(19) United States
(12) Patent Application Publication
(10) Pub. No.: US 2015/0256506 A1
(43) Pub. Date: Sep. 10, 2015

(54) METHOD AND ELECTRONIC DEVICE FOR PERFORMING MESSAGE EXCHANGE

(71) Applicant: HONDA MOTOR CO., LTD., Tokyo (JP)

(72) Inventor: Hiroaki Sawato, Tokyo (JP)

(21) Appl. No.: 14/638,394

(22) Filed: Mar. 4, 2015

(30) Foreign Application Priority Data
Mar. 6, 2014 (JP) 2014-044094
Mar. 6, 2014 (JP) 2014-044095

(51) Int. Cl. H04L 12/58; H04L 29/08; G06F 3/0482; G06F 3/0481; G06F 3/0484

(52) U.S. Cl. CPC H04L 51/38; G06F 3/04817; G06F 3/04842; G06F 3/0482; H04L 51/046; H04L 67/10

(57) ABSTRACT

A method and electronic device are provided for easily performing message exchange with other vehicles while travelling. An electronic device includes: a display control unit that displays a plurality of stylized (and fixed) phrase messages in a first display region of a display unit, and displays a second icon corresponding to a communication destination in a second display region of the display unit; and a message processing unit that, in response to at least one first icon being designated in a state in which a plurality of first icons is being displayed in the first display region, sends the stylized (and fixed) phrase message corresponding to the first icon designated to the communication destination corresponding to the second icon displayed in the second display region, via a wireless communication unit.

This application is based on and claims the benefit of priority from Japanese Patent Application Nos. 2014-044094 and 2014-044095, respectively filed on 6 Mar. 2014, the contents of which are incorporated herein by reference.

### BACKGROUND OF THE INVENTION

1. Field of the Invention

The present invention relates to a method of performing exchange of messages between electronic devices (hereinafter also referred to as “mobile device”) carried on vehicles travelling on a road, motorcycles, bicycles, pedestrians, etc. (hereinafter also referred to as “vehicle, etc.”); and an electronic device. For example, as the mobile device, a portable terminal device such as a smartphone possessed by a vehicle passenger, a tablet terminal, PDA, notebook computer, mobile telephone and other portable electronic devices including a wireless communication functions, or a navigation device including PND, on-board navigation device, or the like can be exemplified.

In particular, it relates to a method and an electronic device for performing exchange of messages whereby a user riding in the vehicle, etc. can perform the give and take of messages such as chat by an electronic device by way of an easy operation via wireless communication with another mobile device.

In addition, it is related to a method and electronic device for performing exchange of messages that can, in the case of sending a message mistakenly, perform the transmission of a cancellation intention of this message by an easy operation.

2. Related Art

There is the need of group members, dividing between a plurality of vehicles, wanting to enjoy conversation through wireless communication between members riding in different vehicles during the long distance travel of a day trip, for example.

For example, touring, etc. has a need for setting information of good points for sightseeing in advance, and sending messages at this site, while looking at the outside scenery. In addition, for example, there is a need for performing message exchange for confirmation at a moment approaching a rest area that has been decided beforehand.

In this way, upon having a conversation of chat format by way of text data, it is desired to be able to easily operate proposal messages related to “restroom break”, “coffee time”, “convenience store”, “rest”, etc. having high frequency of use, and reply messages, etc. of “roger” relative to these.

In addition, upon having a conversation of chat format by way of text data, it is desired to be able to easily operate a proposal message related to “restroom break”, “coffee time”, “convenience store”, “rest”, etc. having high frequency of use, reply messages such as “roger” and “NO” relative to these, proposal messages such as a change in communication destination, reply messages relative to these, etc.

In addition, it is desired to be able to easily operate transmission of a cancellation intention of a mistakenly sent message.

Patent Document 1 discloses an invention related to chat between users (travelling persons) via mobile telephones set to a positional information setting mode. Patent Document 1 discloses an invention related to a mobile telephone that displays an icon indicating an own device and an icon indicating another user set in positional information display mode on a road map displayed on the mobile telephone set to position information setting mode, and by selecting the icon corresponding to a specific user B, displays a message creation screen related to this user B, and by inputting a message via this message creation screen and pressing a send button, sends this message to the mobile telephone of this user B.

Patent Document 1: Japanese Unexamined Patent Application, Publication No. 2007-166189

### SUMMARY OF THE INVENTION

The invention described in Patent Document 1 is merely a device that displays a message creation screen relative to the corresponding other party by selecting the specific other party, and requires the user to perform a reply operation upon inputting a message.

The invention described in Patent Document 1 requires the user to perform a reply operation upon inputting a message. Such an operation feels troublesome in a case of promptness being demanded.

With the invention described in Patent Document 1, group members divided between a plurality of vehicles, for example, during the long distance travel of a day trip, must input in detail the conversation via wireless communication between members riding in different vehicles during long distance travel of a day trip, for example, proposal messages such as “restroom break”, “coffee time”, “convenience store” and “rest”, which have high frequency of use, reply messages such as “roger” relative to these, and the like, and thus it is not possible to easily operate.

In addition, with the invention described in Patent Document 1, group members divided between a plurality of vehicles, for example, during the long distance travel of a day trip, must input in detail the conversation via wireless communication between members riding in different vehicles during long distance travel of a day trip, for example, proposal messages such as “restroom break”, “coffee time”, “convenience store” and “rest”, which have high frequency of use, reply messages such as “roger” and “NO” relative to these, and the like, proposal messages such as change of communication destination, reply messages relative to this, and the like, and thus it is not possible to easily operate.

Furthermore, it is not possible to easily operate cancellation of messages mistakenly sent.

The present invention has been made taking such problems into account, and has an object of providing a method and electronic device for performing the exchange of messages via wireless communication, upon having a conversation of chat format by way of character data, by users riding in vehicles, etc. using a mobile device, that enables communication messages having high frequency of use, reply messages related thereto, etc. to be stylized and made into fixed marks/pictures/graphics (hereinafter also referred to as “stylized (and fixed)”) to make for simple operation.

In addition, it is an object to provide a method and electronic device for, in the case of having sent a message mistakenly, transmits the exchange of messages via wireless communication and a cancellation intention of a sent message, by the user riding in a vehicle, etc. using a mobile device that enables to perform cancelling this message by a simple operation. Hereinafter, a message according to stylized and fixed mark/picture/graphic is also referred to as a “stylized (and fixed) phrase message”

According to a first aspect of the present invention, a program for causes an electronic device (e.g., the electronic device 2) including a wireless communication unit (e.g., the wireless communication unit 20 described later) and a display unit (e.g., the display unit 11 described later) to function as: a display control unit (e.g., the display control unit 43 described later) that displays a plurality of first icons corresponding to a plurality of stylized (and fixed) phrase messages in a first display region of the display unit, and displays a second icon corresponding to a communication destination in a second display region of the display unit; and a message processing unit (e.g., the message processing unit 45 described later) that, in response to at least one first icon being designated in a state in which the plurality of first icons is being displayed in the first display region, sends a stylized (and fixed) phrase message corresponding to the first icon designated to the communication destination corresponding to the second icon displayed in the second display region via the wireless communication unit.

According to the program of the first aspect, by stylizing a message having high frequency of use and associating this to a first icon, from creation to transmission of the message is automatically processed by simply selecting the corresponding first icon.

It is thereby possible for the user of an automobile, etc. to intuitively and easily perform a sending operation of the stylized (and fixed) phrase message in a short time, and thus smooth communication can be achieved.

According to a second aspect of the present invention, in the program as described in the first aspect, the plurality of stylized (and fixed) phrase messages includes a first stylized (and fixed) phrase message (e.g., “roger” described later) for replying to a stylized (and fixed) phrase message from a communication destination.

According to a third aspect of the present invention, in the program as described in the first or second aspect, the plurality of stylized (and fixed) phrase messages includes a second stylized (and fixed) phrase message (e.g., “thank you” described later) for replying in a case of a communication destination having addressed the stylized (and fixed) phrase message transmitted by the electronic device (e.g., the electronic device 2 described later).

According to the program as described in the second or third aspect, it is possible for the user of an automobile, etc. to intuitively and easily perform a sending operation of a reply message to a question or request, or a reply message in the case of addressing the question or request, whereby smooth communication can be achieved.

According to a fourth aspect of the present invention, the program as described in any one of the first to third aspects causes the electronic device (e.g., the electronic device 2 described later) to function so that the display control unit (e.g., the display control unit 43 described later), in response to having received a stylized (and fixed) phrase message from the communication destination corresponding to the second icon via the wireless communication unit (e.g., the wireless communication unit 20 described later), displays a first icon corresponding to the received stylized (and fixed) phrase message in the second display region of the display unit (e.g., the display unit 11 described later) to be associated with the second icon corresponding to the communication destination displayed in the second display region.

According to a fifth aspect of the present invention, the program as described in the fourth aspect causes the electronic device (e.g., the electronic device 2 described later) to function so that the display control unit (e.g., the display control unit 43 described later) further, in a case of a first icon corresponding to a stylized (and fixed) phrase message received previously being displayed upon displaying a first icon corresponding to the received stylized (and fixed) phrase message to be associated with the second icon in the second display region, overwrites the first icon corresponding to the received stylized (and fixed) phrase message over the stylized (and fixed) phrase message received previously.

According to the program of the fourth or fifth aspect, it is possible to display by associating a first icon corresponding to the newest message information for every second icon corresponding to a message sender.

It is thereby possible to intuitively and easily confirm messages received from a communication destination that is currently communicable.

According to a sixth aspect of the present invention, the program as described in any one of the first to fifth aspects causes the electronic device to function so that the display control unit (e.g., the display control unit 43 described later) displays a current position of the electronic device (e.g., the electronic device 2) on the display unit, and displays the first display region outside of a display region showing the current position of the electronic device.

According to the program of the sixth aspect, it is possible to achieve both display of the current positions of the electronic devices and sending of messages.

According to a seventh aspect of the present invention, a method for an electronic device (e.g., the electronic device 2 described later) including a wireless communication unit (e.g., the wireless communication unit 20 described later) and a display unit (e.g., the display unit 11 described later) to exchange stylized (and fixed) phrase messages with a communication destination includes: a display control step (e.g., the display control step described later) of displaying a plurality of first icons corresponding to a plurality of stylized (and fixed) phrase messages in a first display region of the display unit, and displaying a second icon corresponding to the communication destination in a second display region of the display unit; and a message processing step (e.g., the message processing step described later) of, in response to at least one first icon being designated in a state in which the plurality of first icons is being displayed in the first display region, sending the stylized (and fixed) phrase message corresponding to the first icon designated to a communication destination corresponding to a second icon displayed in the second display region via the wireless communication unit.

According to an eighth aspect of the present invention, in the method as described in the seventh aspect, the plurality of stylized (and fixed) phrase messages includes a first stylized (and fixed) phrase message (e.g., “roger” described later) for replying to a stylized (and fixed) phrase message from a communication destination.

According to a ninth aspect of the present invention, in the method as described in the seventh or eighth aspect, the plurality of stylized (and fixed) phrase messages includes a second stylized (and fixed) phrase message (e.g., “thank you” described later) for replying in a case of a communication destination having addressed the stylized (and fixed) phrase message transmitted by the electronic device (e.g., the electronic device 2 described later).

According to a tenth aspect of the present invention, in the method as described in any one of the seventh to ninth aspects, the display control step (e.g., the display control step described later) includes a step of, in response to having received a stylized (and fixed) phrase message from the communication destination corresponding to the second icon via the wireless communication unit (e.g., the wireless communication unit 20 described later), further displaying a first icon corresponding to the stylized (and fixed) phrase message received in the second display region to be associated with the second icon corresponding to the communication destination displayed in the second display region.

Similar effects as the program of the first to fourth aspects are exerted by the method of the seventh to tenth aspects.

According to an eleventh aspect of the present invention, an electronic device (e.g., the electronic device 2) includes: a wireless communication unit (e.g., the wireless communication unit 20 described later); a display unit (e.g., the display unit 11 described later); a display control unit (e.g., the display control unit 43 described later) that displays a plurality of first icons corresponding to a plurality of stylized (and fixed) phrase messages in a first display region of the display unit, and displays a second icon corresponding to a communication destination in a second display region of the display unit; and a message processing unit (e.g., the message processing unit 45 described later) that, in response to at least one first icon being designated in a state in which the plurality of first icons is being displayed in the first display region, sends a stylized (and fixed) phrase message corresponding to the first icon designated to the communication destination corresponding to the second icon displayed in the second display region via the wireless communication unit.

According to a twelfth aspect of the present invention, in the electronic device (e.g., the electronic device 2 described later) as described in the eleventh aspect, the plurality of stylized (and fixed) phrase messages includes a first stylized (and fixed) phrase message (e.g., “roger” described later) for replying to a stylized (and fixed) phrase message from a communication destination.

According to a thirteenth aspect of the present invention, in the electronic device as described in the eleventh or twelfth aspect, the plurality of stylized (and fixed) phrase messages includes a second stylized (and fixed) phrase message (e.g., “thank you” described later) for replying in a case of a communication destination having addressed the stylized (and fixed) phrase message transmitted by the electronic device (e.g., the electronic device 2 described later).

According to a fourteenth aspect of the present invention, in the electronic device (e.g., the electronic device 2 described later) as described in any one of the eleventh to thirteenth aspects, the display control unit (e.g., the display control unit 43 described later), in response to having received a stylized (and fixed) phrase message from the communication destination corresponding to the second icon via the wireless communication unit (e.g., the wireless communication unit 20 described later), displays a first icon corresponding to the received stylized (and fixed) phrase message in the second display region to be associated with the second icon corresponding to the communication destination displayed in the second display region.

Similar effects as the program of the first to fourth aspects are exerted by the electronic device of the eleventh to fourteenth aspects.

According to a fifteenth aspect of the present invention, a program causes an electronic device (e.g., the electronic device 2) including a wireless communication unit (e.g., the wireless communication unit 20 described later) and a display unit (e.g., the display unit 11 described later) to function as: a display control unit (e.g., the display control unit 43 described later) that displays a second icon corresponding to a communication destination in a second display region of the display unit, and displays a plurality of first icons corresponding to a plurality of stylized (and fixed) phrase messages in a first display region of the display unit; and a message processing unit (e.g., the message processing unit 45 described later) that, in response to at least one second icon and one first icon being designated in a state in which a second icon corresponding to a communication destination is being displayed in the second display region and the plurality of first icons is being displayed in the first display region, sends a stylized (and fixed) phrase message corresponding to the first icon designated to the communication destination corresponding to the second icon designated via the wireless communication unit, in which the plurality of stylized (and fixed) phrase messages includes at least one predetermined stylized (and fixed) phrase message that can reference a sent stylized (and fixed) phrase message.

According to a sixteenth aspect of the present invention, in the program as described in the fifteenth aspect, the predetermined stylized (and fixed) phrase message is a stylized (and fixed) phrase message conveying a cancellation intention of the sent stylized (and fixed) phrase message.

According to the program of the fifteenth and sixteenth aspects, by stylizing a message having high frequency of use and associating this to a first icon, from creation to transmission of the message is automatically processed by simply selecting the corresponding first icon. In addition, in the case of sending a message mistakenly, or a case of wanting to cancel a proposal already sent, by simply associating to a function conveying a cancellation intention, from creation to transmission of the stylized (and fixed) phrase message conveying the cancellation intention is automatically processed.

It is thereby possible for the driver of an automobile, etc. and fellow passengers to intuitively and easily perform a sending operation of a stylized (and fixed) phrase message in a short time while travelling, whereby smooth communication can be achieved.

According to a seventeenth aspect of the present invention, the program as described in the fifteenth or sixteenth aspect causes the electronic device (e.g., the electronic device 2 described later) to function so that, in response to having received a stylized (and fixed) phrase message from a communication destination corresponding to the second icon via the wireless communication unit (e.g., the wireless communication unit 20 described later), the display control unit (e.g., the display control unit 43 described later) further displays a first icon corresponding to the stylized (and fixed) phrase message received in the second display region of the display unit (e.g., the display unit 11 described later), to be associated with the second icon corresponding to the communication destination displayed in the second display region.

According to an eighteenth aspect of the present invention, the program as described in the seventeenth aspect causes the electronic device (e.g., the electronic device 2 described later) to function so that the display control unit (e.g., the display control unit 43 described later) further, in a case of a first icon corresponding to a stylized (and fixed) phrase message received previously being displayed upon displaying a first icon corresponding to the received stylized (and fixed) phrase message to be associated with the second icon in the second display region, overwrites the first icon corresponding to the received stylized (and fixed) phrase message over the stylized (and fixed) phrase message received previously.

According to the program of the seventeenth or eighteenth aspect, it is possible to display by associating a first icon corresponding to the newest message information for every second icon corresponding to a message sender.

It is thereby possible to intuitively and easily confirm messages received from a communication destination that is currently communicable.

According to a nineteenth aspect of the present invention, the program as described in the seventeenth or eighteenth aspect causes the electronic device (e.g., the electronic device 2 described later) to function so that the message processing unit (e.g., the message processing unit 45 described later) further, in the case of the stylized (and fixed) phrase message corresponding to the first icon designated being the predetermined stylized (and fixed) phrase message, sends to the communication destination corresponding to the second icon designated by adding information identifying a stylized (and fixed) phrase message sent previously to the communication destination corresponding to the second icon designated to the stylized (and fixed) phrase message corresponding to the first icon designated; and the display control unit, in the case of the stylized (and fixed) phrase message received being the predetermined stylized (and fixed) phrase message, further displays the second icon corresponding to the communication destination in the second display region, as well as displaying the first icon corresponding to the predetermined stylized (and fixed) phrase message received to be associated with the second icon, and displaying the first icon identified by the information added to the predetermined stylized (and fixed) phrase message.

According to a twentieth aspect of the present invention, the program as described in the seventeenth or eighteenth aspect causes the display control unit (e.g., the display control unit 43 described later) to function, in a case of the stylized (and fixed) phrase message received being the predetermined stylized (and fixed) phrase message, so as to further display the first icon corresponding to the stylized (and fixed) phrase message received in the second display region, as well as displaying the first icon corresponding to a stylized (and fixed) phrase message most recently received from the communication destination corresponding to the second icon.

According to the program of the nineteenth or twentieth aspect, it is possible for the sender creating the stylized (and fixed) phrase message conveying the cancellation intention to cancel a most recent message by simply an operation of selecting a first icon corresponding to the stylized (and fixed) phrase message conveying the cancellation intention. In addition, the receiver of the stylized (and fixed) phrase message conveying the cancellation intention can intuitively and easily confirm which message the stylized (and fixed) phrase message conveying the cancellation intention set as the target.

According to a twenty-first aspect of the present invention, the program as described in the seventeenth aspect causes the electronic device (e.g., the electronic device 2 described later) to function so that the display control unit (e.g., the display control unit 43 described later) further, in a case of a first icon corresponding to a stylized (and fixed) phrase message received previously being displayed upon displaying a first icon corresponding to the received stylized (and fixed) phrase message to be associated with the second icon, displays in the second display region the first icon corresponding to the received stylized (and fixed) phrase message and a stylized (and fixed) phrase message received previously in received time information order.

According to the program of the twenty-first aspect, since two frames for chronological order display are provided for each sender (second icon) in the second display region, and first icons corresponding to received stylized (and fixed) phrase messages are displayed in order, it is possible to intuitively and easily confirm in chronological order the newest message and most recent message prior thereto received from a communication destination that is currently communicable.

According to a twenty-second aspect of the present invention, a method for an electronic device (e.g., the electronic device 2) including a wireless communication unit (e.g., the wireless communication unit 20 described later) and display unit (e.g., the display unit 11 described later) to exchange stylized (and fixed) phrase messages with a communication destination includes: a display control step (e.g., the display control step described later) of displaying a second icon corresponding to a communication destination in a second display region of the display unit, and displaying a plurality of first icons corresponding to a plurality of stylized (and fixed) phrase messages in a first display region of the display unit; and a message processing step (e.g., the message processing step described later) of, in response to at least one second icon and one first icon being designated in a state in which a second icon corresponding to a communication destination is being displayed in the second display region and the plurality of first icons is being displayed in the first display region, sending a stylized (and fixed) phrase message corresponding to the first icon designated to the communication destination corresponding to the second icon designated via the wireless communication unit, in which the plurality of stylized (and fixed) phrase messages includes at least one predetermined stylized (and fixed) phrase message that can reference a sent stylized (and fixed) phrase message.

According to a twenty-third aspect of the present invention, in the method as described in the twenty-second aspect, the predetermined stylized (and fixed) phrase message is a stylized (and fixed) phrase message conveying a cancellation intention of the sent stylized (and fixed) phrase message.

According to a twenty-fifth aspect of the present invention, in the method as described in the twenty-second or twenty-third aspect, the display control step (e.g., the display control step described later) includes a step of, in response to having received a stylized (and fixed) phrase message from a communication destination corresponding to the second icon via the wireless communication unit (e.g., the wireless communication unit 20 described later), further displaying a first icon corresponding to the stylized (and fixed) phrase message received in the second display region of the display unit (e.g., the display unit 11 described later), to be associated with the second icon corresponding to the communication destination displayed in the second display region.

Similar effects as the program of the fifteenth to seventeenth aspects are exerted by the method of the twenty-second to twenty-fourth aspects.

According to a twenty-fifth aspect of the present invention, an electronic device (e.g., the electronic device 2) includes: a display unit (e.g., the display unit 11 described later); a display control unit (e.g., the display control unit 43 described later) that displays a second icon corresponding to a communication destination in a second display region of the display unit, and displays a plurality of first icons corresponding to a plurality of stylized (and fixed) phrase messages in a first display region of the display unit; and a message processing unit (e.g., the message processing unit 45 described later) that, in response to at least one second icon and one first icon being designated in a state in which a second icon corresponding to a communication destination is being displayed in the second display region and the plurality of first icons is being displayed in the first display region, sends a stylized (and fixed) phrase message corresponding to the first icon designated to the communication destination corresponding to the second icon designated via a wireless communication unit (e.g., the wireless communication unit 20 described later), in which the plurality of stylized (and fixed) phrase messages includes at least one predetermined stylized (and fixed) phrase message that can reference a sent stylized (and fixed) phrase message.

According to a twenty-sixth aspect of the present invention, in the electronic device (e.g., the electronic device 2 described later) as described in the twenty-fifth aspect, the predetermined stylized (and fixed) phrase message is a stylized (and fixed) phrase message conveying a cancellation intention of the sent stylized (and fixed) phrase message.

According to a twenty-seventh aspect of the present invention, in the electronic device (e.g., the electronic device 2 described later) as described in the twenty-fifth or twenty-sixth aspect, in response to having received a stylized (and fixed) phrase message from the communication destination corresponding to the second icon via the wireless communication unit (e.g., the wireless communication unit 20 described later), the display control unit (e.g., the display control unit 43 described later) displays the first icon corresponding to the stylized (and fixed) phrase message received in the second display region of the display unit to be associated with the second icon corresponding to the communication destination displayed in the second display region.

Similar effects as the programs of the fifteenth to seventh aspects are exerted by the electronic device of the twenty fifth to twenty seventh aspects.

According to the present invention, it is possible to for the driver of a vehicle, etc., fellow passengers, etc. to intuitively and easily perform the sending operation of stylized (and fixed) phrase messages, upon having a conversion of chat format by way of text data, etc. or conversation similar thereto between electronic devices carried on the vehicles, etc. In addition, it is possible to intuitively and easily confirm messages received from a communication destination that is currently communicable. In addition, for the replies to received messages, it is possible to intuitively and easily perform a sending operation of a reply stylized (and fixed) phrase message in a short time, as well as being possible for the receiver of the reply stylized (and fixed) phrase message to intuitively and easily confirm the reply.

In addition, in regards to a stylized (and fixed) phrase message conveying the cancellation intention of an already sent message, it is possible to intuitively and easily perform the sending operation of a stylized (and fixed) phrase message conveying a cancellation intention in a short time, as well as being possible for the receiver of the stylized (and fixed) phrase message conveying the cancellation intention to intuitively and easily confirm the stylized (and fixed) phrase message conveying the cancellation intention.

### BRIEF DESCRIPTION OF THE DRAWINGS

FIG. 1 is a block diagram showing the functional configuration of an electronic device 2 of a first embodiment;

FIG. 2 is a block diagram showing the data organization stored in a storage unit 32 of the first embodiment;

FIG. 3A is a view showing an example of displaying first icons in a first display region and second icons in a second display region of a display unit of the electronic device of a vehicle (K) (hereinafter referred to as “display unit of own device (K)”) of the first embodiment;

FIG. 3B is a view showing a display example of the display unit of the own vehicle (K) in a case of the own vehicle (K) proposing a “convenience store”;

FIG. 3C is a view showing a display example of the display unit of the own vehicle (K) when receiving a “roger message” from another vehicle (L);

FIG. 3D is a view showing a display example of the display unit of the own vehicle (K) when receiving a “roger message” from another vehicle (M);

FIG. 3E is a view showing a display example of the display unit of the own vehicle (K) in a case of the own vehicle (K) sending a “thank you” message;

FIG. 4A is a view showing an example of displaying first icons in a first display region and second icons in a second display region of a display unit of an electronic device of the own vehicle (L) (hereinafter referred to as “display unit of own vehicle L”) of the first embodiment;

FIG. 4B is a view showing a display example of the display unit of the vehicle (L) in a case of receiving a “convenience store” proposal message from the other vehicle (K);

FIG. 4C is a view showing a display example of the display unit of the vehicle (L) when sending a “roger message” to the other vehicle (K);

FIG. 4D is a view showing a display example of the display unit of the own vehicle (L) when receiving a “roger message” from the other vehicle (M);

FIG. 4E is a view showing a display example of the display unit of the own vehicle (L) when receiving a “thank you” message from the other vehicle (K);

FIG. 5 is a view showing another display example of a list of the first icons;

FIG. 6 is a view showing a display example of switching buttons for performing switching of the list of the first icons;

FIG. 7 is a view showing a display example of the first icons in a case of a pedestrian, electronic cart user, or the like wanting to cross a road;

FIG. 8 is a view showing an operation example of sharing traffic obstacle information by sending/receiving vehicle-to-vehicle;

FIG. 9A is a view showing an example of displaying second icons in a second region and first icons in a first region of a display unit of an electronic device of the own vehicle (K) (hereinafter referred to as, “display unit of own vehicle (K)”) of an enhanced first embodiment;

FIG. 9B is a view showing a display example of a display unit of the vehicle (K) in a case of the own vehicle (K) proposing a “convenience store”;

FIG. 9C is a view showing a display example of the display unit of the own vehicle (K) when receiving a “roger message” from the other vehicle (L);

FIG. 9D is a view showing a display example of the display unit of the own vehicle (K) when receiving a “roger message” from the other vehicle (M);

FIG. 9E is a view showing a display example of the display unit of the own vehicle (K) when receiving a “stylized (and fixed) phrase message conveying a cancellation intention” from the other vehicle (L);

FIG. 9F is a view showing a display example of the display unit of the own vehicle (K) in a case of the own vehicle (K) cancelling a “convenience store” proposal message by way of a message “conveying a cancellation intention”.

FIG. 9G is a view showing a display example of the display unit of the own vehicle (K) when receiving a “stylized (and fixed) phrase message conveying a cancellation intention” from the other vehicle (M);

FIG. 10A is a view showing an example of displaying second icons in the second display region and first icons in the first display region of the display unit of the electronic device of the own vehicle (L) (hereinafter referred to as “display unit of own vehicle L”) of an enhanced first embodiment;

FIG. 10B is a view showing a display example of the display unit of the own vehicle (L) in a case of receiving a “convenience store” proposal message from the other vehicle (K);

FIG. 10C is a view showing a display example of the display unit of the own vehicle (L) when sending a “roger message” to the other vehicle (K);

FIG. 10D is a view showing a display example of the display unit of the own vehicle (L) when receiving a “roger message” from the other vehicle (M);

FIG. 10E is a view showing a display example of the display unit of the own vehicle (L) when the own vehicle (L) sends a “stylized (and fixed) phrase message conveying a cancellation intention”;

FIG. 10F is a view showing a display example of the display unit of the own vehicle (L) in the case of receiving a message “conveying a cancellation intention” of a “convenience store” proposal message from the other vehicle (K);

FIG. 10G is a view showing a display example of the display unit of the own vehicle (L) when receiving a “stylized (and fixed) phrase message conveying a cancellation intention” from the other vehicle (M);

FIG. 11A is a view showing an example of additionally setting “customizing” a user unique message in a stylized (and fixed) phrase message of the electronic device of the enhanced first embodiment; and

FIG. 11B is a view showing a display example of a stylized (and fixed) phrase message in which a user unique message has been additionally set (customized) in the electronic device of the enhanced first embodiment.

### DETAILED DESCRIPTION OF THE INVENTION

### First Embodiment

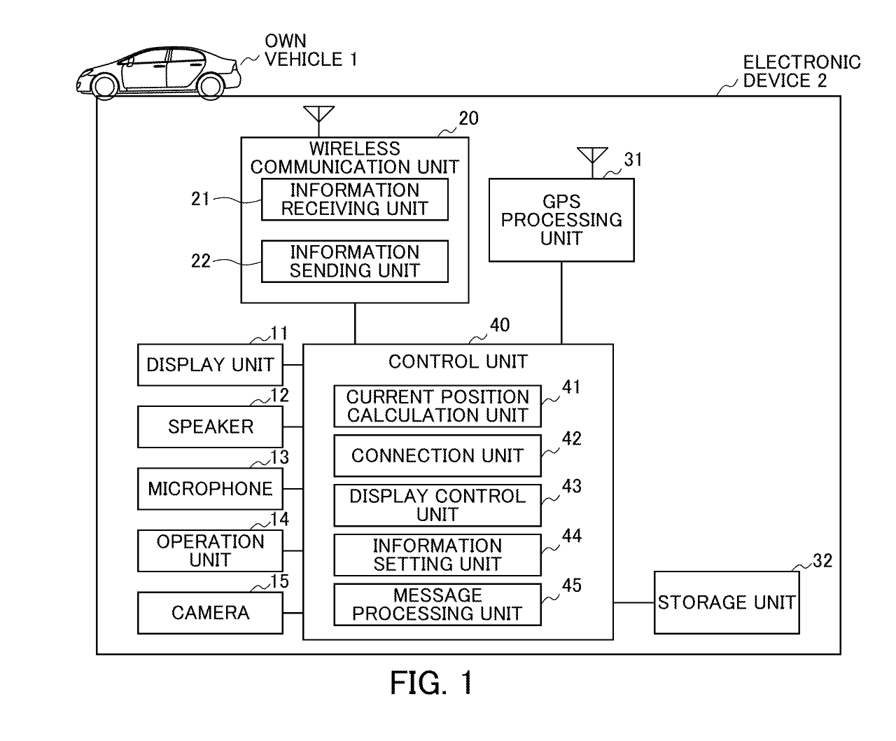

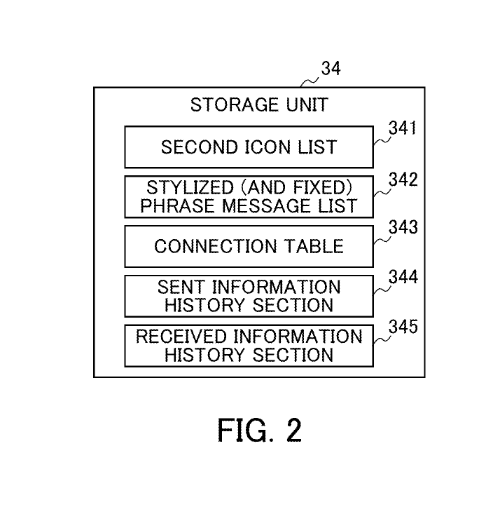

Hereinafter, a preferred embodiment of an electronic device according to the present invention will be explained while referencing the drawings. First, an electronic device according to a first embodiment will be explained by referencing FIG. 1.

### Functional Configuration of Electronic Device According to First Embodiment

A vehicle, etc. according to the first embodiment indicates an own vehicle 1 travelling on a road, and other vehicles, motorcycles, bicycles, pedestrians, etc.

It should be noted that cases including roadside communication equipment along the road, facilities along the road, stores along the road, etc. are referred to as “vehicles, facilities, etc.” for convenience. It should be noted that, in the electronic device (hereinafter also referred to as “mobile device, etc.”) equipped to (or possessed by or inside) vehicles, facilities, etc., an identification ID for uniquely identify the electronic device is assigned, and according to the identification ID, it is possible to identify whether the electronic device is equipped to a vehicle, motorcycle, bicycle, pedestrian or the like, or is equipped to roadside communication equipment along the road, a facility along the road, a store along the road, etc.

The electronic device 2 according to the first embodiment includes navigation devices such as on-board navigation devices and PND (Personal Navigation Device), portable terminal devices such as a smartphone, tablet terminals, PDA, notebook computers, mobile telephones, and other portable electronic devices equipped with a wireless communication function.

It should be noted that software for stylized (and fixed) phrase message sending/receiving according to the first embodiment may be installed in advance. In addition, it may be downloaded as appropriate from a predetermined server, Cloud, or the like.

The functional configuration of the electronic device 2 according to the first embodiment of the present invention will be explained by referencing FIG. 1. FIG. 1 is a functional block diagram showing the functional configuration of the electronic device 2 according to the first embodiment.

The electronic device 2, which is inside of the own vehicle 1 according to the first embodiment (hereinafter also referred to as “mobile device” or simply “own device” unless otherwise stated) is configured to include a control unit 40, wireless communication unit 20, GPS receiver, GPS processing unit 31, storage unit 32, display unit 11, speaker 12, microphone 13, operation unit 14 and camera 15, and is carried in a mobile means such as a vehicle.

### Message Exchange

As the stylized (and fixed) phrase message exchanged between the own device and electronic device carried by another vehicle, etc. (hereinafter also referred to as “other mobile device” or simply “other device” unless otherwise stated), for example, when any group members make a touring drive in a plurality of vehicles, there are proposal messages such as “restroom break”, “coffee time”, “convenience store” and “rest” and reply messages such as “roger” relative to these, and reply messages such as “thank you” conveying an expression of gratitude in the interaction with a partner, and proposal messages such as a change of communication destination among the group, reply messages relative to this, and the like, interchanging in real-time with a member's car.

In addition, for example, there are stylized (and fixed) phrase messages related to greetings such as “hello”, and advance unseen traffic obstacles from oncoming vehicles, etc.

In addition, for example, at intersections, etc., there are stylized (and fixed) phrase messages (e.g., stylized (and fixed) phrase message such as “crossing”) of a pedestrian present notification, notification of road crossing, or the like.

It should be noted that, for example, the mobile device can receive stylized (and fixed) phrase messages such as of coupon information, discount information big bargain sale information from stores along the road, etc.; special event information and sightseeing information of an area from public facilities along the road, etc.; weather information, traffic information from an institution along the road, etc.

It should be noted that, as the messages exchanged between the own device and other device, other than stylized (and fixed) phrase messages, for example, it is possible to include un-stylized (and fixed) phrase messages such as camera images, text messages and voice mail.

In addition, the messages exchanged between the own device and other device can include the identification ID for uniquely identifying the own device and other devices, time information, attributes related to the sender, information classification, information urgency and information importance. Herein, the attributes related to the sender can include vehicle-type information in the case of the sender being a vehicle.

It should be noted that, although the vehicle, etc. of the first embodiment is the own vehicle 1, in the case of being a pedestrian, it can include attributes related to the sender, i.e. attribute information like the pedestrian being a child, elderly person, or other. It should be noted that, in case such as facilities along the road, stores along the road or the like, it can include attributes related to the sender, i.e. business-type information of the facility along the road, store along the road or the like.

Hereinafter, if not particularly stated, the information will be collectively referred to as “communication information”.

The wireless communication unit 20, in the case of sending/receiving with another mobile device, for example, in a case of sending/receiving with a server WiFi direct communication enabling 1:N communication or 1:1 communication, it is possible to implement a plurality of communication protocols so as to be able to make communication such as WiFi access point connection or 3G/LTE (3^{rd} Generation/Long Term Evolution).

By WiFi direct communication, the own device can make direct wireless communication with another mobile device in the surroundings that is in a communicable area about 100 m away. In addition, with the mobile device within the communicable area as an access point, it is possible to make wireless communication with another mobile device that is within the communicable area of this mobile device. By configuring in this way, for example, it becomes possible for the own device to expand the communicable area.

In addition, the own device is configured to be able to perform wireless communication with a server such as a VICS (registered trademark) center or navigation server, for example, by way of WiFi access point connection, 3G/LTE, etc. The wireless communication unit 20 can receive data such as map information and traffic information, for example, from such a server.

It should be noted that the communication protocol possessed by the wireless communication unit 20 is not limited to WiFi direct communication, WiFi access point connection or 3G/LTE. The wireless communication unit 20 may possess a communication protocol enabling 1:1 communication and 1:N communication for directly sending/receiving with another mobile device, and a communication protocol for sending/receiving with servers, etc.

The wireless communication unit 20 has an information receiving unit 21 that receives communication information from another mobile device, and an information sending unit 22 that sends communication from the own device to another mobile device.

The GPS processing unit 31 receives radio waves including positioning data containing the latitude/longitude of the current site from a plurality of GPS satellites via the GPS receiver (not illustrated), and calculates the current position of the own device based on the positioning data and map information of roads currently travelling.

The display unit 11 is configured, for example, by a liquid crystal display, etc., and can display various icons, etc. expressing communication information to the user according to a display control unit 43 described later.

Next, it will be explained how the various icons are displayed on the display unit 11. It should be noted that the display on the display unit 11 explained hereinafter is controlled by the display control unit 43 described later.

### First Icon

It is possible to simplify the processing of the stylized (and fixed) phrase messages by associating the stylized (and fixed) phrase message, for example, plurality of stylized (and fixed) phrase messages such as communication information within a group such as proposal messages of “restroom break”, “coffee time”, “convenience store”, “rest”, etc. and reply messages such as “roger” to the proposal message; a message conveying an expression of gratitude such as “thank you” to convey the expression of gratitude in the interaction with another party; greetings such as “hello”; and “traffic obstacle information” like “upcoming traffic delay”; with an icon expressing as a message symbol (hereinafter also referred to as “first icon”).

In addition, as the stylized (and fixed) phrase message such as of a notification of road crossing, by associating a wish/desire message such as “crossing”, a communication message to report a decision/action such as “crossing”, a message reporting a reply/gratitude such as “thank you” conveying an expression of gratitude in the interaction with the other party, etc. with first icons, it is possible to simplify the processing of stylized (and fixed) phrase messages.

In addition, it is possible to associate a message such as “sale” as the transmitted stylized (and fixed) phrase message of a shop facing the road with a first icon.

In this way, the message symbol is an appropriate size that is easy to see when displayed on the screen. In addition, in the case of a map being displayed on the screen, it is a size for which the occupied space on the screen is not too large.

### Effects of First Icon

By configuring in this way, for example, it is possible to exert the following such effects.

(1) When displaying a text message as is, it is not intuitively understood and requires reading; whereas, due to being a figure or graphical, intuitive understanding is possible.
(2) In the case of displaying a text message as is, although the coverage area overhangs to the screen center side, in the case of a message of an icon representation, due to being able to set to a constant size, it is possible to suppress the overhanging by this amount.
(3) By preparing message icons as sender/receiver common patterns, storing and saving these in each device, using not the image data itself in the communication data, but rather identification information, and displaying by calling the data stored on the receiver side based on this, it is possible to lighten the sending/receiving data by this amount, which is convenient in communication, especially short-distance wireless direct communication.

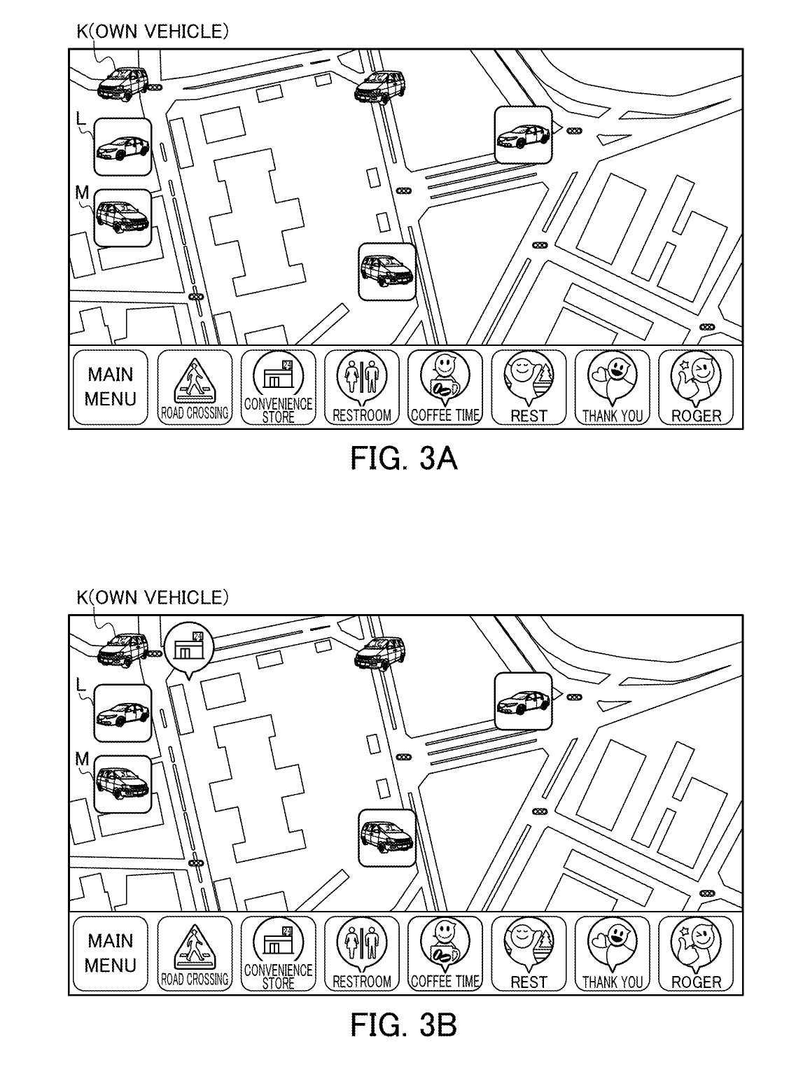

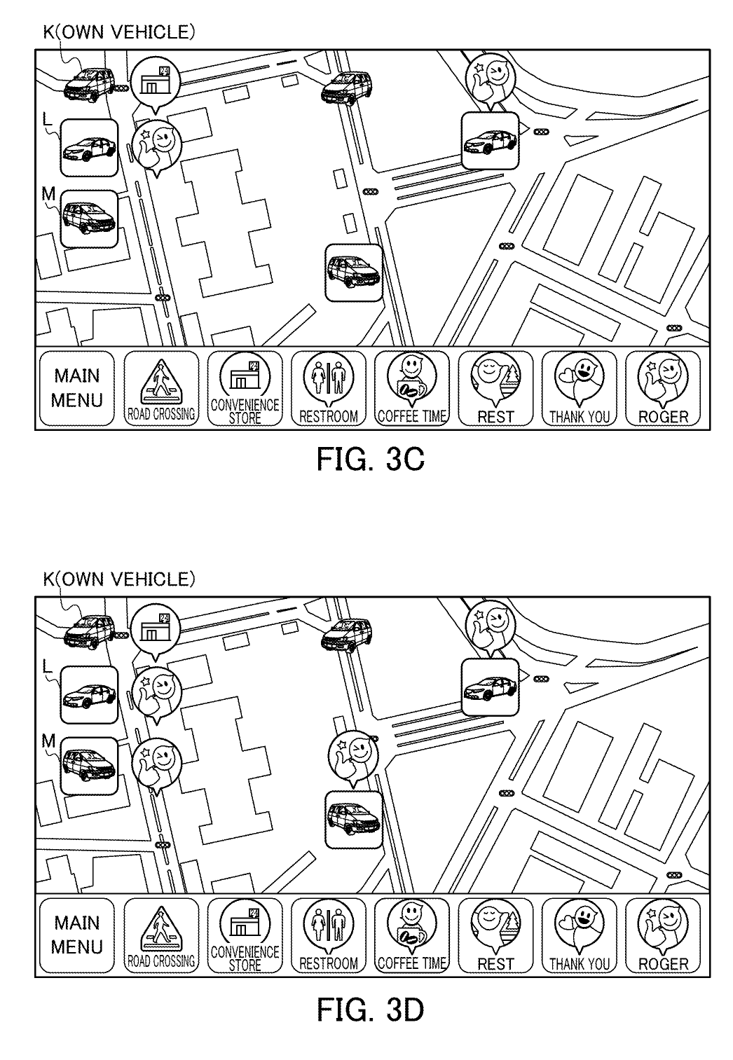

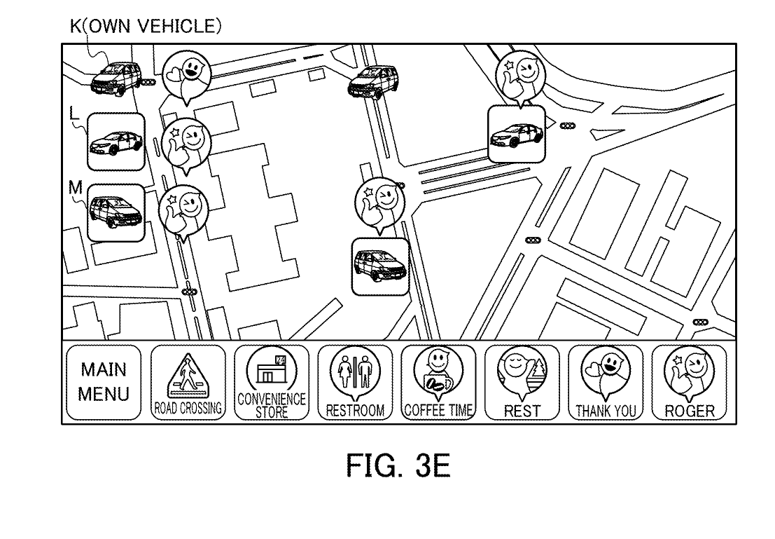

As shown in FIG. 3A, for example, a list of the first icons corresponding to a selectable stylized (and fixed) phrase messages is displayed in a predetermined display region (hereinafter also referred to as “first display region”) provided at the lower side, for example, on the display unit 11. As described later, in the case of sending a stylized (and fixed) phrase message to another mobile device, by selecting the first icon correspond to a stylized (and fixed) phrase message to be sent from the list of the first icons displayed in the first display region, the user can easily send this stylized (and fixed) phrase message by way of the message processing unit 45 described later.

The list of the selectable first icons is not limited to the size of the screen of the display unit 11.

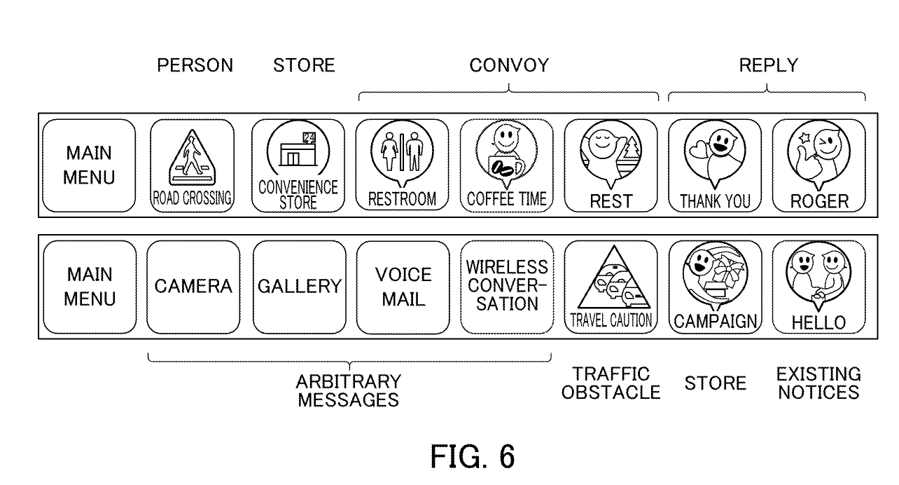

For example, as shown in FIG. 6, the menu button at the left end serves as a switching button, and it is possible to configure so as to perform switching between a plurality of menus by depressing the menu button.

It should be noted that the first display region is not limited to the lower side on the display unit 11, and as a modified example, it can be set to a predetermined position such as the upper side, for example, on the display unit 11.

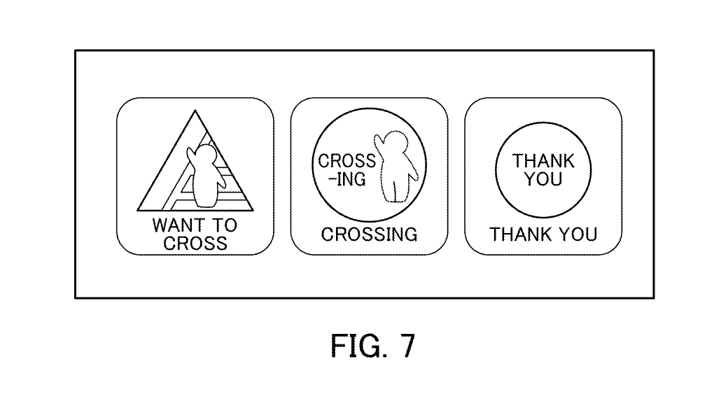

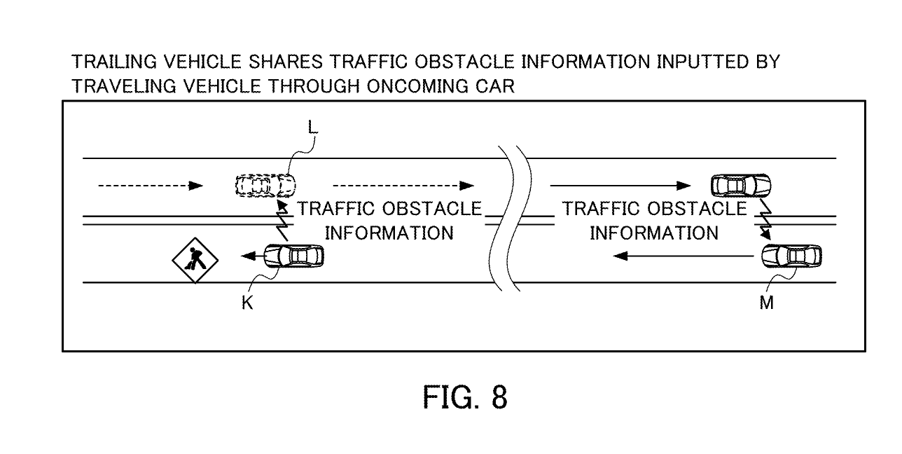

In particular, as the display of the first display region of the display unit 11 in the electronic device 2 equipped to a pedestrian, electric cart user, etc., it is possible to display a list of the first icons consisting of stylized (and fixed) phrase messages such as notifications of road crossing (e.g., a first icon (“crossing”) expressing a message appealing to automobiles, etc. in the vicinity with a wish/desire to cross, a first icon (“crossing”) expressing a message to report to automobiles, etc. in the vicinity of the decision/action to cross the road, and a first icon (“thank you”) expressing a message of a reply/gratitude to convey the feeling of gratitude in response to finishing road crossing and the automobiles, etc. in the vicinity for stopping), as shown in FIG. 7.

In this way, it is possible to improve the ease of use for the user by appropriately setting the list display of the first icons in response to the use situation of the user.

### Second Icon

As shown in FIG. 3A, the mobile device is identified by the icon expressed as a character (hereinafter referred to as “second icon”), and is displayed on the display unit 11. The second icon corresponding to a currently communicable other mobile device is displayed in a predetermined display region (hereinafter referred to as “second display region”) provided at the upper left side, for example, on the display unit 11.

It should be noted that, as the second icon displayed in the second display region, it may be configured so as to include a second icon corresponding to the own device. In this case, in order to distinguish between the second icon correspond to the own device and the second icon correspond to the other mobile device, it is possible to separate both so as to make a region displaying the second icon (K) corresponding to the own device to be above the region displaying the second icon (L), second icon (M), etc. corresponding to the other mobile devices, for example, as shown in FIG. 3A.

It should be noted that the second display region is not limited to be at the upper left side, for example, on the display unit 11, and as a modified example, it can be set to a predetermined position such as the upper right side, for example, on the display unit 11.

The display sequence of the second icons corresponding to the other mobile devices displayed in the second display region can be displayed following a priority order set in advance (e.g., setting touring partners as top priority, etc.). In the case of the priority order being the same, for example, it is possible to display following the order of Japanese syllabary (alphabetical order). In addition, it is possible to display following the connected time, e.g., following the reverse chronological order or chronological order of connected times. For the setting of such display sequences, it is possible to set by way of the information setting unit 44 described later.

As shown in FIG. 3A, the second icon (L), second icon (M), etc. corresponding to the currently communicable other mobile devices are displayed along with the second icon (K) corresponding to the own device, on the currently travelled road map displayed on the display unit 11. The second icon (K) corresponding to the own device is displayed on the currently travelled road map, based on the current position of the own device calculated by the GPS processing unit 31. In addition, the second icon (L), second icon (M), etc. corresponding to the other mobile devices are displayed on the currently travelled road map, based on the current positions of the other mobile devices calculated based on the GPS information including the latitude/longitude of the other mobile device received via the information receiving unit 21 of the wireless communication unit 20.

As described later, the display sequence, etc. of second icons in the second display region can be set by way of the information setting unit 44 in advance to associate between the own device and second icon.

As shown in FIG. 3C, to be associated with the respective second icons (L) corresponding to the other mobile devices displayed in the second display region, the first icon corresponding to a message received from the communicable other mobile device (L) is displayed in the second display region in the vicinity of this second icon, for example.

### Display of Own Vehicle

In the case of being set by the information setting unit 44 so that the second icon corresponding to the own device is displayed in the second display region, for example, the first icon (“convenience store”) corresponding to the newest message sent by the own device as shown in FIG. 3B can be displayed in the second display region in the vicinity of this second icon (K), for example, to be associated with the second icon (K) corresponding to the own device displayed in the second display region.

### Display on Currently Travelled Road Map

In addition, as shown in FIG. 3C, on the currently travelled road map displayed on the display unit 11, the first icon (e.g., “roger”) corresponding to the message received from the other device (L), to be associated with the second icon (L) corresponding to the other device (L), is displayed over this second icon (L) for example.

By configuring in this way, it is possible to easily understand the stylized (and fixed) phrase message received from the other device in an intuitive manner, by the display according to the association between the second icon and first icon displayed on the road map.

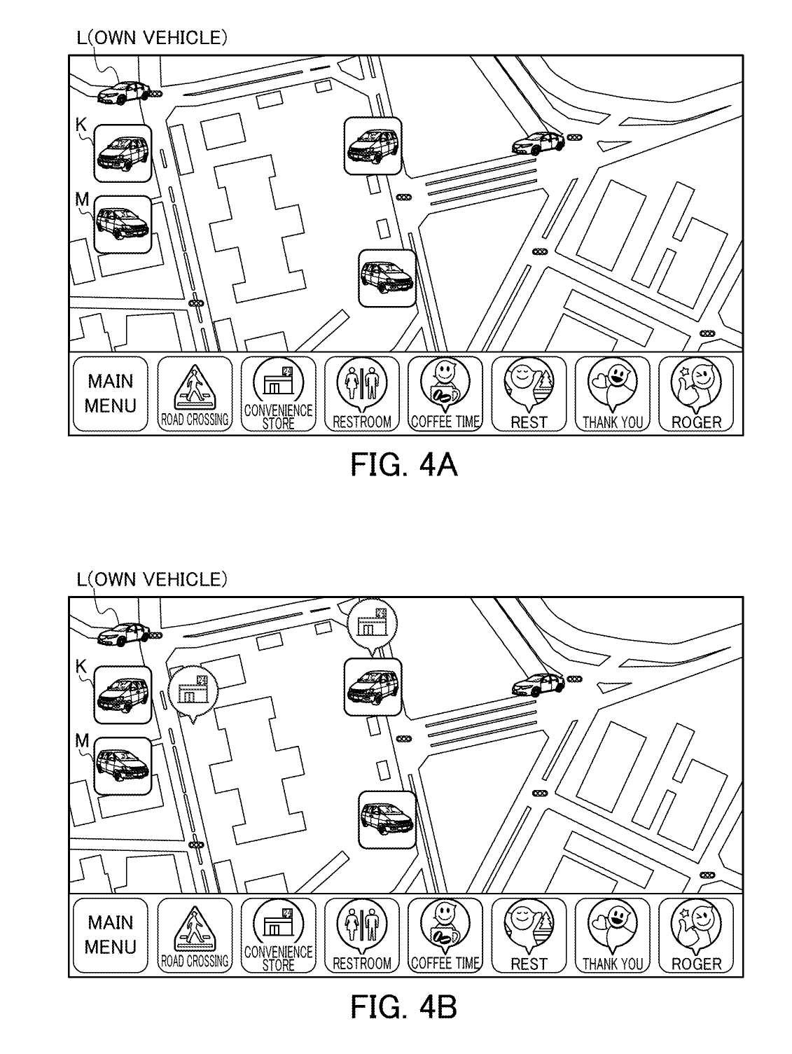

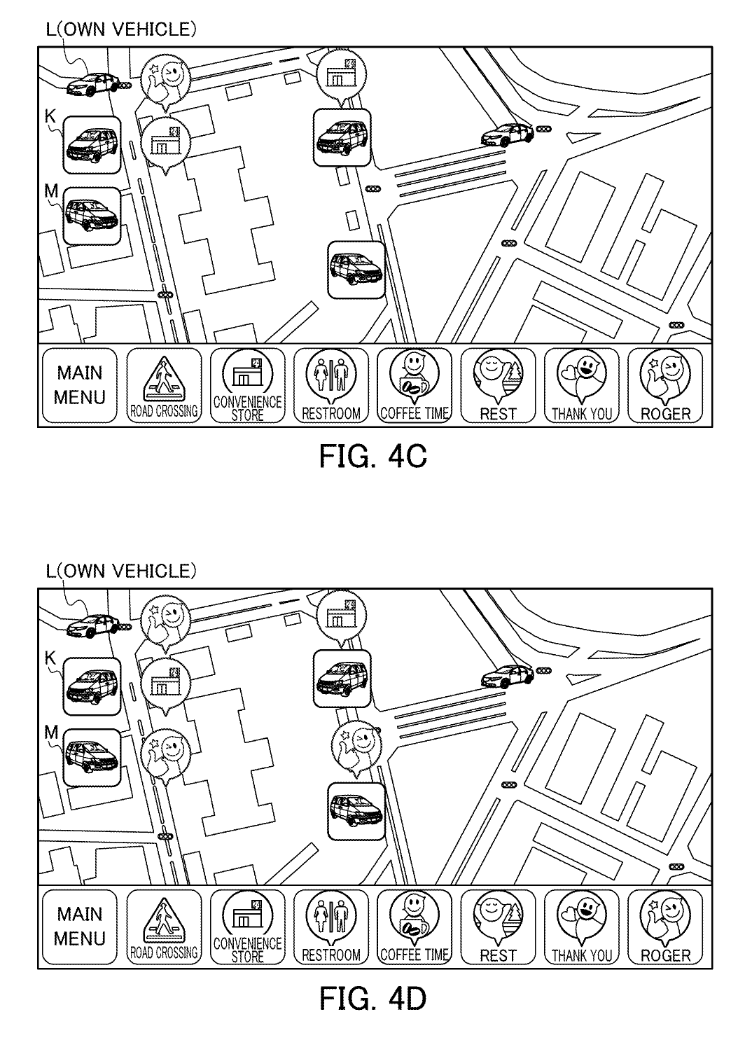

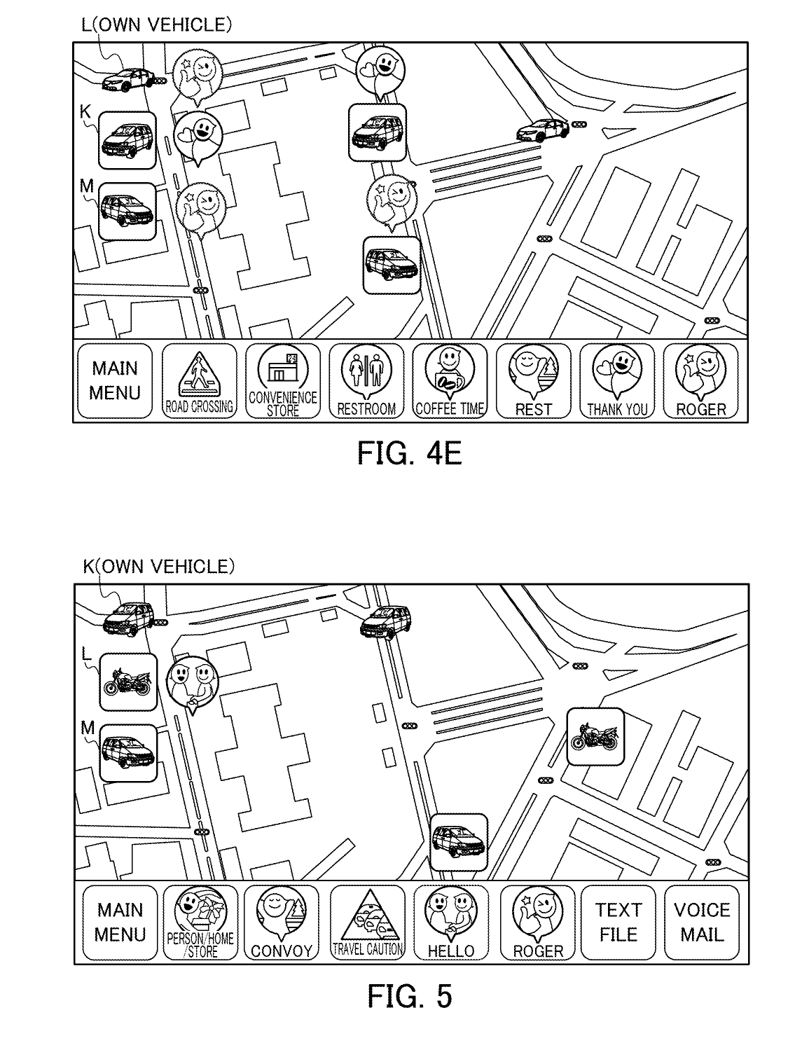

It should be noted that the screen examples of navigation in FIGS. 3A to 3E and 4A to 4E are display mode examples of north up, and not display mode examples in which the travelling direction of the own vehicle is heading up; however, in a display mode in which the travelling direction of the own vehicle is heading up, the display of first icons can be displayed so as not to interfere with the route guide display of the navigation screen.

### Display of Own Vehicle

In addition, although not illustrated, on the currently travelled road map displayed on the display unit 11, the first icon corresponding to the newest message received by the own device (e.g., “convenience store”) can be displayed to be associated with the second icon corresponding to the own vehicle displayed on the road map, over this second icon, for example.

It can be set by the information setting unit 44 whether to display, in association with the second icon corresponding to the own device displayed on the currently travelled road map displayed on the display unit 11, the first icon corresponding to the newest message sent by the own device.

A touch panel is laminated on the surface of the display unit 11, and can accept operations of the user. Selection operations to select any position on the display unit 11 (so-called taps), and slide operations to cause a finger to move after selecting any position on the display unit 11 (so-called swipe, flick) are included in the operations accepted by the touch panel in the present embodiment. In addition, the touch panel is configured by a multi-touch panel that can simultaneously sense a plurality of contact points. Operations accepted via the touch panel are received and processed in the control unit 40.

The speaker 12 performs audio output to the user, and the microphone 13 collects voices, etc. originating from the user.

The operation unit 14 can be configured by operation buttons, a touch panel-type input device or the like, whereby various selections and instructions are inputted by the user. It should be noted that the touch panel provided on the display screen of the display unit 11 also functions as the operation unit 14.

In addition, it is also possible to input various selections and instructions from the user voice inputted via the microphone 13 by way of voice recognition technology.

### Storage Unit 32

The storage unit 32 is configured to include ROM, RAM, etc., stores data set by the user via the operation unit 14 to be readable along with control programs, etc. for controlling the electronic device 2 being stored therein, and provides a work area to the control unit 40.

In addition, in the storage unit 32, a plurality of stylized (and fixed) phrase messages is stored in advance such as stylized (and fixed) phrase messages such as contact information with a group like proposals such as “restroom break”, “coffee time”, “convenience store” and “rest” and replies such as “roger” relative to proposals, for example, to send as communication information; reply messages such as “thank you” to convey a reply/gratitude in correspondence with the other party, proposal messages such as a change in destination within the group and reply messages thereto; stylized (and fixed) phrase messages related to greetings such as “hello”, advance unseen traffic obstacles like “upcoming traffic delay” from oncoming cars, etc.; and stylized (and fixed) phrase messages such as pedestrian present notifications and notifications of road crossing in a crossing intersection or the like (e.g., stylized (and fixed) phrase messages such as “want to cross” and “crossing”).

The details will be explained hereinafter.

The storage unit 32 stores a second icon list 341, a stylized (and fixed) phrase message list 342, connection table 343, sent information history section 344 and received information history section 345.

The second icon list 341 stores a plurality of records constituted from the identification information of second icons (hereinafter also referred to as “second icon identification ID”), second icons corresponding to the identification ID, etc.

It should be noted that the second icon list 341 may be installed in advance. In addition, it may be downloaded as appropriate from a predetermined server, Cloud, or the like.

The stylized (and fixed) phrase message list 342 stores a plurality of records consisting of the identification IDs of stylized (and fixed) phrase messages, stylized (and fixed) phrase messages, first icon identification IDs associated with these stylized (and fixed) phrase messages, first icons, etc.

The stylized (and fixed) phrase message list 342 may be installed in advance. In addition, it may be downloaded as appropriate from a predetermined server, Cloud, or the like. By configured in this way, the stylized (and fixed) phrase messages and first icons corresponding to the stylized (and fixed) phrase messages are commonly stored in all electronic devices 2.

The connection table 343 stores a plurality of records constituted from communication address information of the own device, other mobile devices communicable with the own device, etc. (e.g., IP address, MAC address, etc.), which is generated and updated by the connection processing unit 42 described later, the second icon identification IDs corresponding to the mobile devices, etc., data of second icons corresponding to the second icon identification IDs, time information, positional information, etc.

It should be noted that, as described later, it may be configured so as to store, only in the case of the identification setting unit 44 customizing the data of the second icon corresponding to a second icon identification ID according to the instruction of the user, the data of this second icon in the connection table 343.

The sent information history section 344 stores the history of communication information sent by the own device.

The received information history section 345 stores the history of communication information received from the other mobile devices, etc. communicable with the own device.

By configuring in this way, the user can inquire received communication information according to the received time/date order, sender order, etc. In addition, the user can do a text search of data included in the communication information.

For the sent communication information, similarly, it is possible to inquire according to the sent time/date order, sender order, etc. and text search the data included in the communication information.

By configuring in this way, a search inquiry of the exchange of communication information between group members, and search inquiry of communication information from a store providing coupons or discount information become possible.

It should be noted that, in order to display the currently travelled road map on the display unit 11, it may store road maps being used in route guidance processing such as 2D map information, 3D map information, road shape data, facility data, and store data, by providing a map information database in the storage unit 32. In addition, in the case of receiving map information being used in route guidance processing from a navigation server, it may be configured so as to make the map information being used in route guidance processing received from the navigation server stored in the storage unit 32.

### Control Unit

The control unit 40 includes a CPU (Central Processing Unit), etc., and performs overall control of the electronic device 2. The control unit 40 includes a current position calculation unit 41, connection processing unit 42, display control unit 43, information setting unit 44 and message processing unit 45.

### Current Position Calculation Unit

In the case of receiving a connection request, connection confirmation reply, communication information, etc. from the other mobile device, etc. via the information receiving unit 21, the current position calculation unit 41 calculates the current position of the other mobile device, etc. based on GPS information included in a connection request, connection confirmation reply, communication information, etc., and map information of a road during current travel.

### Connection Processing Unit

The connection processing unit 42 stores, in the connection table 343, communication address information of the other mobile devices, etc. communicable with the own device (e.g., IP address, MAC address, etc.), second icon identification ID corresponding to the mobile device, etc., second icons corresponding to the identification ID, time information, positional information, etc.

More specifically, the connection processing unit 42 sends, via the information sending unit 22, a connection request including communication address information for identifying the own device (e.g., IP address, MAC address, etc.), second icon identification ID corresponding to the own device, time information, positional information, etc., according to the instructions of the user. Then, based on a connection confirmation from the other mobile device, etc. replying to this connection request, a record including the communication address information of the other mobile device, etc., second icon identification ID corresponding to this mobile device, etc., time information, positional information, etc. is created in the connection table 343.

In the case of a second icon being selected from the second icon list stored in the storage unit 32, it is possible to acquire data of this second icon from the second icon list and store in the connection table 343.

The connection processing unit 42, when receiving a connection request from the other mobile device, etc., stores a record including the communication address information of the other mobile device, etc., second icon identification ID corresponding to this mobile device, data of the second icon, time information, positional information, etc. in the connection table 343.

Then, the connection processing unit 42 sends, via the information sending unit 22, a connection confirmation reply, etc. including address information of the own device, the second icon identification ID corresponding to the own device, time information, positional information, etc. to the other mobile device, etc. having received the connection request.

The connection processing unit 42 updates the connection information with the other mobile device, etc. created in the connection table 343, as appropriate, based on the connection confirmation, etc. with the other mobile device, etc. By configuring in this way, it is possible to keep the connection information related to the currently communicable other mobile devices, etc. (communication address information, second icon identification ID corresponding to the mobile device, data of second icon, time information, positional information, etc.) in the latest state.

### Display Control Unit

The display control unit 43 displays the second icons corresponding to the currently communicable other mobile devices in the second display region on the display unit 11, as shown in FIG. 3A, for example, based on the connection information with the other mobile devices, etc. stored in the communication table 343 created by the connection processing unit 42.

At this time, for example, as shown in FIG. 3A, the display control unit 43 may be configured so as to display the second icon corresponding to the own device in the second display region. In this case, in order to distinguish between the second icon corresponding to the own device and the second icon corresponding to the other mobile device, etc., for example, it is possible to separate both so as to position the region displaying the second icon (K) corresponding to the own device above the region displaying the second icon (L), second icon (M), etc. corresponding to the other mobile devices, etc.

The display control unit 43 can display the second icons corresponding to the other mobile devices, etc. displayed in the second display region following the priority order set in advance by the information setting unit 44 (e.g., setting touring partners as top priority, etc.) In the case of the priority order being the same, for example, it is possible to display following the order of Japanese syllabary (alphabetical order). In addition, it is possible to display following the connected time, e.g., following the reverse chronological order or chronological order of connected times set in advance by the information setting unit 44.

The display control unit 43, for example, displays the second icon (L), second icon (M), etc. corresponding to the currently communicable other mobile devices, along with the second icon (K) corresponding to the own device, on the currently travelled road map displayed on the display unit 11, as shown in FIG. 3A. The second icon (K) corresponding to the own device is displayed on the currently travelled road map, based on the current position of the own vehicle 1 calculated by the GPS processing unit 31. In addition, the second icon (L), second icon (M), etc. corresponding to the other mobile devices is displayed on the currently travelled road map, based on the current positions of the other mobile devices calculated by the current position calculation unit 41, based on the GPS information including the longitude/latitude of the other mobile devices received via the information receiving unit 21 of the wireless communication device 20.

The display control unit 43, for example, displays the lists of first icons (menu bar) corresponding to selectable stylized (and fixed) phrase messages, in the first display region provided at a lower side, for example, on the display unit 11, as shown in FIG. 3A.

It should be noted that, as mentioned earlier, the list of selectable first icons (menu bar) is not limited to the size of the screen of the display unit 11.

For example, as shown in FIG. 6, the menu buttons on the left end serve as switching buttons, and by depressing a menu button, it is possible to configure to perform switching between a plurality of menus.

The display control unit 43 displays a first icon (“roger”) corresponding to a message received via the information receiving unit 21 from the communicable other mobile device (L) in the second display region to be associated with each of the second icons (L) corresponding to the other mobile devices displayed in the second display region, as shown in FIG. 3C, for example.

More specifically, for example, it is processed as follows.

The connection processing unit 42 extracts, from the communication records addressed to the own device received via the information receiving unit 21 from the communicable other mobile device (L), the second icon identification ID corresponding to the mobile device (L) of the sender, first icon identification ID corresponding to the stylized (and fixed) phrase message sent from the sender, time information, GPS information of the mobile device of the sender, etc.

The connection processing unit 42 causes the current position of the mobile device of the sender to be calculated by the current position calculation unit 41, based on the GPS information of the mobile device of the sender and the map information of the road during current travel.

The connection processing unit 42 adds and updates connection information related to the mobile device of the sender in the connection table 343.

The connection processing unit 42 stores received information in the received information history section 342, based on the communication record addressed to the own device received via the information receiving unit 21 from the communicable other mobile device (L).

Based on the data extracted by the connection processing unit 42, stylized (and fixed) phrase message list 342, etc., the display control unit 43 displays the first icon (“roger”) corresponding to the received message to be associated with the second icon (L) corresponding to the other mobile device (L) displayed on the currently travelled road map, along with displaying the first icon (“roger”) corresponding to the message received from the other mobile device (L) to be associated with the second icon (L) displayed in the second display region, as shown in FIG. 3C, for example, on the display unit 11.

### Overwrite Display

The display control unit 43 can overwrite a first icon corresponding to a received message on the first icon corresponding to a previously received message, in the case of the first icon corresponding to the previously received message being displayed upon displaying the first icon corresponding to a message received to be associated with the second icon (e.g., L) in the second display region.

In addition, in the display of the first icon, the display control unit 43 can do highlighted display based on attributes related to a sender, information classification, information urgency, information importance, or the like.

### Display of Own Device

In the case of being set by the information setting unit 44 so as to display the second icon corresponding to the own device in the second display region, the display control unit 43 can display in the second display region, to be associated with the second icon (K) corresponding to the own device displayed in the second display region, the first icon (“convenience store”) corresponding to a newest message sent by the own device, as shown in FIG. 3B.

### Display on Currently Travelled Road Map

The display control unit 43 displays, to be associated with each of the second icons (L) corresponding to the other mobile devices (L), displayed on the currently travelled road map displayed on the display unit 11, the first icon (“roger”) corresponding to the message received from the communicable other mobile devices (L), over this second icon, for example, as shown in FIG. 3C.

By configuring in this way, the user can easily understand a stylized (and fixed) phrase message received from a currently communicable other mobile device, from the display according to the association between the second icon and first icon displayed on the road map.

In this case, the display control unit 43 displays a first icon corresponding to the newest message sent from the mobile device (i.e. received by the own device from the mobile device).

### Display of Own Device

In addition, according to the settings of the information setting unit 44, the display control unit 43 can display, to be associated with the second icon corresponding to the own device displayed on the currently travelled road map displayed on the display unit 11, the first icon corresponding to the newest message sent by the own device over this second icon, for example.

### Information Setting Unit

As has already been mentioned, the information setting unit 44 can set in advance the display mode of the first icons and the display mode of the second icons.

The information setting unit 44 sets the display sequence of the second icons displayed in the second display region in advance. For example, it is possible to set a priority order to second icons (e.g., setting touring partners as top priority, etc.). In the case of the priority order being the same, for example, it is possible to display following the order of Japanese syllabary (alphabetical order). In addition, it is possible to set so as to display following the connected time, e.g., following the reverse chronological order or chronological order of connected times.

The information setting unit 44 sets the association between the own device and second icon in advance. By configuring in this way, it is possible to display the own device by way of this second icon on the other mobile devices communicable with the own device.

The information setting unit 44 sets whether or not to display a second icon corresponding to the own device in the second display region.

In this case, as shown in FIG. 3B, it is possible to display in the second display region, to be associated with the second icon (K) corresponding to the own device displayed in the second display region, the first icon (“convenience store”) corresponding to the newest message sent by the own vehicle 1.

The information setting unit 44 sets whether or not to display the first icon corresponding to the newest message sent by the own device to be associated with the second icon corresponding to the own device, displayed on the currently travelled road map displayed on the display unit 11.

It should be noted that the setting information set in advance by the information setting unit 44 can be changed by way of an instruction of the user during operation of the display control unit 43. By configuring in this way, it is possible to change the display method flexibly.

### Message Processing Unit

The message processing unit 45, in the case of sending communication information according to the instruction of the user to the other mobile device, acquires the current position of the own vehicle 1 via the GPS processing unit 31, and acquires the current time via a timing unit, generates communication information, and sends the communication information to the other information source via the information sending unit 22.

### Sending of Stylized (and Fixed) Phrase Message

In response to one first icon being selected from the appearance of a plurality of first icons displayed in the first display region, according to a tap operation of the user, for example, the message processing unit 45 sends a stylized (and fixed) phrase message corresponding to the selected first icon to the mobile device, etc. corresponding to the second icon displayed in the second display region of the display unit 11 via the wireless communication unit 20.

At this time, the message processing unit 45 stores the sent information as log information in the sent information history section 344.

The message processing unit 45 acquires from the connection table 343 the communication address information (e.g., IP address, MAC address, etc.) of the mobile device, etc. corresponding to the second icon displayed in the second display region of the display unit 11, sets this communication address to the communication destination address, sets the communication address of the own device as the sender address, creates a communication record setting the second icon identification ID corresponding to the own device, the first icon identification ID corresponding to the selected stylized (and fixed) phrase message, time information, GPS information of the own vehicle 1, etc. in the sending data buffer, and sends to the mobile device, etc. corresponding to the second icon displayed in the second display region of the display unit 11, via the information sending unit 22.

The message processing unit 45 stores the above-mentioned information sent to the mobile device, etc. to the sent information history section 341.

It should be noted that, in the case of being set by the information setting unit 44 so that the second icon corresponding to the own device is displayed in the second display region, the display control unit 43 displays in the vicinity, for example, the first icon corresponding to the above-mentioned stylized (and fixed) phrase message sent by the own device, to be associated with the second icon corresponding to the own device displayed in the second display region.

### Sending Same Message to Plurality of Mobile Devices

In addition, the message processing unit 45 can broadcast a selected stylized (and fixed) phrase message via the information sending unit 22.

### (System Configuration of Electronic Device 2)

Next, an example of the configuration of the electronic device 2 will be explained.

The electronic device 2 is configured to include navigation devices such as on-board navigation devices and PND (Personal Navigation Device), portable terminal devices such as a smartphone, tablet terminals, PDA, notebook computers, mobile telephones, and other portable electronic devices equipped with a wireless communication function.

It should be noted that, in the case of the vehicle, etc. being a bicycle or pedestrian, the electronic device 2 is configured to include a portable terminal (smartphone, etc.).

In addition, in the case of the vehicle and facility, etc. being a store along the road, facility along the road, communication equipment along the road, etc., the electronic device can also adopt the same configuration as the above-mentioned electronic device 2. In addition, it is also possible to employ the above-mentioned computer having a wireless communication function, e.g., personal computer, tablet PC, PDA or the like.

The embodiments of this control unit 40, current position calculation unit 41, connection processing unit 42, display control unit 43, information setting unit 44 and message processing unit 45 of the electronic device 2, for example, can be implemented as programmable processors, or as computer programs for execution by a programmable computer.

In addition, it can be implemented in the form of a special purpose logical circuit, for example, FPGA or ASIC, firmware, and digital electronic circuit.

In addition, by recording a program for realizing the functions of the electronic device 2 in a recording medium readable by a computer, it may be realized by reading the program recorded on this recording medium into the computer and executing.

“Computer” referred to herein includes the OS and hardware such as peripheral devices. In addition, “recording medium readable by a computer” includes portable media such as flexible disks, magneto-optical disks, ROM and CD-ROM; storage devices such as the hard-disks equipped in computer systems; and the like.

In addition, the method steps of one embodiment of the present invention can be implemented by one or a plurality of programmable processors or computers executing computer programs for realizing the functions of one embodiment of the present invention. In addition, it is also possible to realize the method steps by way of a special purpose logical circuit, for example, FPGA or ASIC, firmware, and digital electronic circuit.

### (Operations of Electronic Device 2)

The operations of the electronic device 2 will be explained. They will be explained while referencing FIGS. 3A to 3E and 4A to 4E. These show examples of a case of performing message exchange while all of the mobile device (K), mobile device (L) and mobile device (M) are moving.

FIGS. 3A to 3E show display screens displayed on the mobile device (K).

FIGS. 4A to 4E show display screens displayed on the mobile device (L).

It should be noted that in order to facilitate understanding of the explanation, FIGS. 3A to 3E and FIGS. 4A to 4E serve as screen display examples for a case of setting by the information setting unit 44 so as to display the second icon corresponding to the own device in the second display region.

The display screen displayed on the electronic device 2 in the case of setting so as not to display the second icon corresponding to the own device in the second display region can be explained by reading as drawings in which the own device (K) is not displayed for FIGS. 3A to 3E, and as drawings in which the own device (L) is not displayed for FIGS. 4A to 4E; therefore, a detailed explanation is omitted.

The mobile device (K), mobile device (L) and mobile device (M) are in a communicable state. In FIG. 3A and FIG. 4A, the display control unit 11 is displaying the mobile device (K), mobile device (L) and mobile device (M) as being in a connected state.

Herein, in FIG. 3A, the message processing unit 45 sends identification ID of the first icon (“convenience store”), time information, GPS information, etc. to the mobile device (L) and mobile device (M), in response to the first icon (“convenience store”) being selected from the list of the first icons displayed in the first display region by the user (K) of the mobile device (K).

By configuring in this way, the user (K) of the mobile device (K) can easily make a “convenience store” proposal to the members of the group.

In FIG. 3B, the first icon (“convenience store”) is displayed in the second display region to be associated with the second icon (K) of the own device, according to the display control unit 43.

In FIG. 4B, it is displayed on the mobile device (L) that the “convenience store” proposal message arrived from the mobile device (K). The first icon (“convenience store”) is displayed in the second display region to be associated with the second icon (K) in the second display region, as well as the first icon (“convenience store”) being displayed to be associated with the second icon (K) displayed on the currently travelled road map.

By configuring in this way, the user (L) of the mobile device (L) can easily understand in an intuitive manner that there was a “convenience store” proposal from the mobile device (K).

In response to the first icon (“roger”) being selected from the list of first icons displayed in the first display region by the user (L) of the mobile device (L), the message processing unit 45 sends the identification ID of the first icon (“roger”), time information, GPS information, etc. to the mobile device (K) and mobile device (M).

By configuring in this way, the user (L) of the mobile device (L) can easily make a “roger” reply to the members of the group.

In FIG. 4C, it is displayed on the mobile device (L) that the “roger” message was sent.

In FIG. 3C, it is displayed on the mobile device (K) that the “roger” message arrived from the mobile device (L). To be associated with the second icon (L) in the second display region, the first icon (“roger”) is displayed in the second display region, as well as the first icon (“roger”) being displayed to be associated with the second icon (L) displayed on the currently travelled road map.

By configuring in this way, the user (K) of the mobile device (K) easily understands in an intuitive manner that “roger” was made from the mobile device (L).

Although not illustrated, in response to the first icon (“roger”) being selected from the list of first icons displayed in the first display region by the user (M) of the mobile device (M), the message processing unit 45 sends the identification ID of the first icon (“roger”), time information, GPS information, etc. to the mobile device (K) and mobile device (L).

In FIG. 3D, it is displayed on the mobile device (K) that the “roger” message arrived from the mobile device (M).

Similarly, in FIG. 4D, it is displayed on the mobile device (L) that the “roger” message arrived from the mobile device (M).

Therefore, in response to the first icon (“thank you”) being selected from the list of first icons displayed in the first display region by the user (K) of the mobile device (K), the message processing unit 45 sends the identification ID of the first icon (“thank you”), time information, GPS information, etc. to the mobile device (L) and mobile device (4).

By configuring in this way, the user (K) of the mobile device (K) can make a “thank you” reply to be addressed to the “convenience store” proposal to a member of the group easily.

In FIG. 3E, it is displayed on the mobile device (K) that the “thank you” message was sent.

In FIG. 4E, it is displayed on the mobile device (L) that the “thank you” message arrived from the mobile device (K).

By configuring in this way, the user (L) of the mobile device (L) can easily understand that “thank you” was sent from the user (K) of the mobile device (K).

It should be noted that it is also displayed on the mobile device (M) that the “thank you” message arrived from the mobile device (K).

As mentioned above, by using the communication information of the present invention, it is possible to communicate between cars while traveling.

### Communication Information Example for Pedestrian Crossing

As mentioned earlier, it is possible to make exchanges of stylized (and fixed) phrase messages between a pedestrian or electric cart user and the user of an automobile during travel.

As shown in FIG. 7, the pedestrian or electric cart user, in the case of wanting to cross the road, designates the first icon (“want to cross”) being displayed on the display unit 11 of the own device.

By configuring in this way, the message is broadcasted in the vicinity, and “roger” messages can be received from automobiles, etc. during travel in the vicinity, for example.

Next, the pedestrian or electric cart user designates the first icon (“crossing”) being displayed on the display unit 11 of the own device in order to convey the matter of crossing the road.

Subsequently, by the pedestrian or electric cart user designating the first icon (“thank you”) expressing a message to convey the feeling of gratitude in response to finishing road crossing and the automobiles having stopped, this message is broadcasted in the vicinity.

In this way, since the respective signified contents of the plurality of first icons is assigned matters related in context timewise, it is possible to interactively communicate between a pedestrian or electric cart user and automobiles, etc. during travel, by using the communication information of the present invention.

### Example of Vehicle-To-Vehicle Traffic Obstacle Information

While travelling carrying the electronic device 2 of the present invention in a car, a traffic obstacle may be approached such as unexpected road work or falling objects. In such as case, it may be desired to transfer such traffic obstacle information as reference information to cars passing by or cars behind.

In this case, oncoming cars having received this traffic obstacle information may want to notify other oncoming cars ahead in the moving direction thereof. (In this case, the other oncoming cars are rearward cars for the own car.)

It is difficult to sufficiently handle such traffic obstacle information such as unexpected road work or falling objects, in the case of the vehicle-to-vehicle distance being great (e.g., distance that cannot deliver by WiFi direct communication), or by automatic sending/receiving between cars and roadside having installation positions of the communication means which are fixed.

In such as case, by using the communication information of the present invention, it becomes possible to transmit the traffic obstacle information such as unexpected road work and falling objects from vehicle-to-vehicle.

The operations will be explained hereinafter while referencing FIG. 7.

The own device (K), for example, displays the first icon (“travel caution”) corresponding to the stylized (and fixed) phrase message related to traffic obstacles on the menu of the own device, as shown in FIG. 5.

It should be noted that, in the case of the first icon (“travel caution”) not being displayed, for example, the menu button on the left end serves as a switching button as shown in FIG. 6, and by configuring so as to perform switching between menus by depressing this menu button, the user can display the first icon (“travel caution”) on the screen of the own device (K).

It should be noted that, although not illustrated, the user of the own device (K) can additionally set (customize) a user unique message (traffic information) in the stylized (and fixed) phrase message (“travel caution”) according to the instruction of the user. Then, the own device (K) saves customized information in the storage device 32.

The own device (K) connects wireless communication by approaching the oncoming car (L), and can send to the oncoming car (L) the “travel caution” message by designating the first icon (“travel caution”) according to the operation of the user. The oncoming car (L) displays the “travel caution” message received from the mobile device (K) on the display unit 11, as well as saving in the storage unit 32.

Next, the oncoming car (L) connects wireless communication by approaching a passing by other oncoming car (M) (positioned behind the own device (K)), and sends the “travel caution” message received from the mobile device (K) to the other oncoming car (M).

The other oncoming car (M) displays the “travel caution” message received from the oncoming car (L) on the display unit 11, as well as saving in the storage unit 32.

By configuring in this way, the other oncoming car (M) (positioned rearward of the own device (K)) can receive the message (“travel caution”) related to a traffic obstacle of the leading vehicle (K) through the oncoming car (L), and can display on the display unit 11.

In this way, since it is possible to additionally set a user unique message in the first icon, for example, (“travel caution”) of the stylized (and fixed) phrase message, the additional creation of information by the judgment of the user is possible. In addition, the additional setting becomes an operation that is easy by displaying the input icons on the display unit 11 (e.g., first display unit).

In addition, by preparing along with other first icons on the first display unit, it will not inhibit other operations. For example, with the other first icon (“wireless conversation”), even if during conversation with the other devices around, sending of a “travel caution” message to passing by opposing cars can be performed without trouble.

### Facilities Along Road, or Stores Along Road

The facilities along the road or stores along the road (not illustrated), for example, can be made so as to emphasize much more the advertising from stores, etc. by sending stylized (and fixed) phrase messages related to bargain sales, coupon services, etc. (e.g., “campaign”, “having bargain sales”, “coupons”).

### Roadside Communication Equipment Along Road

The roadside communication equipment along the road (not illustrated) can transmit a stylized (and fixed) phrase message related to important traffic information such as traffic delay information, for example, to vehicles traveling on this road. The own vehicle 1 traveling on a road, when approaching the roadside communication equipment along the road, can display on the display unit 11 of the electronic device 2 that is inside of the own vehicle 1.

At this time, by the roadside communication equipment along the road transmitting the urgency of information and importance of information, the display control unit 43 further emphasizes this stylized (and fixed) phrase message, whereby the driver can intuitively understand that there is traffic delay information.

By configuring in this way, the driver of the own vehicle 1 can easily detect important traffic information.

The following such effects are exerted according to the program, method and electronic device 2 for performing stylized (and fixed) phrase message exchange of the above-mentioned first embodiment explained above.

(1) According to a program for performing stylized (and fixed) phrase message exchange of the above-mentioned first embodiment, in response to at least one first icon being designated in a state in which a plurality of first icons corresponding to a plurality of stylized (and fixed) phrase messages is being displayed in the first display region of the first unit 11, the electronic device sends the stylized (and fixed) phrase message corresponding to the designated first icon.

It is thereby possible for the user of an automobile, etc. to intuitively and easily perform a sending operation of the stylized (and fixed) phrase message in a short time, and thus smooth communication can be achieved.

(2) The plurality of stylized (and fixed) phrase messages include a first stylized (and fixed) phrase message, e.g., “roger”, for replying to a stylized (and fixed) phrase message from a communication destination.

(3) The plurality of stylized (and fixed) phrase messages includes a second stylized (and fixed) phrase message, e.g., “thank you”, for replying in the case of the communication destination addressing a transmitted stylized (and fixed) phrase message of the electronic device.

It is thereby possible for the user of an automobile, etc. to intuitively and easily perform a sending operation of a reply message to a question or request, or a reply message in the case of addressing the question or request, whereby smooth communication can be achieved.

(4) In addition, by way of the program for performing stylized (and fixed) phrase message exchange of the above-mentioned first embodiment, the display control unit 43 displays a first icon corresponding to a received stylized (and fixed) phrase message to be associated with a second icon corresponding to the communication destination displayed in the second display region, in the case of having received a stylized (and fixed) phrase message from the communication destination corresponding to the second icon.

(5) In addition, by way of the program for performing stylized (and fixed) phrase message exchange of the above-mentioned first embodiment, the display control unit 43, in a case of a first icon corresponding to a stylized (and fixed) phrase message previously received being displayed, upon further displaying a first icon corresponding to a stylized (and fixed) phrase message that was received to be associated with a second icon in the second region, overwrites the first icon corresponding to the received stylized (and fixed) phrase message over the first icon corresponding to the stylized (and fixed) phrase message previously received.

According to the programs of (4) and (5), by displaying the first icon corresponding to the newest message information to be associated for every second icon corresponding to the message sender, it is possible to intuitively and easily confirm a message received from a communication destination that is currently communicable.

(6) In addition, by way of the program for performing stylized (and fixed) phrase message exchange of the above-mentioned first embodiment, the display control unit 43 further displays the current position of the electronic device 2 on the display unit 11, and displays the first display region outside of the display region showing the current position of the electronic device 2.

According to the program of (6), it is possible to achieve both display of the current positions of the electronic devices and sending of messages.

(7) A method for the electronic device (2) including the wireless communication unit 20 and display unit 11 to perform stylized (and fixed) phrase message exchange of the above-mentioned first embodiment, in the case of displaying a plurality of first icons corresponding to a plurality of stylized (and fixed) phrase messages in the first display region of the display unit 11, displaying a second icon corresponding to a communication destination in the second display region of the display unit 11 and at least one first icon being designated in a state in which the plurality of first icons is being displayed in the first display region, sends the stylized (and fixed) phrase message corresponding to the designated first icon to the communication destination corresponding to the second icon displayed in the second display region.

(8) The plurality of stylized (and fixed) phrase messages includes a stylized (and fixed) phrase message (e.g., “roger”) for replying to a stylized (and fixed) phrase message from a communication destination.

(9) The plurality of stylized (and fixed) phrase messages includes a stylized (and fixed) phrase message (e.g., “thank you”) for replying in a case of the communication destination addressing the transmitted stylized (and fixed) phrase message of the own device.

(10) Furthermore, in response to receiving a stylized (and fixed) phrase message from the communication destination corresponding to the second icon, a first icon corresponding to the stylized (and fixed) phrase message received is displayed in the second display region to be associated with the second icon corresponding to the communication destination displayed in the second display region.

The same effects as the programs of (1) to (4) are exerted by the methods of (7) to (10).

(11) The electronic device 2 of the above-mentioned first embodiment includes: the display control unit 43 that displays a plurality of first icons corresponding to a plurality of stylized (and fixed) phrase messages in the first display region of the display unit 11, and displays a second icon corresponding to the communication destination in the second display region of the display unit 11; and a message processing unit 45 that, in the case of at least one first icon being designated in a state of a plurality of first icons being displayed in the first display region, sends a stylized (and fixed) phrase message corresponding to the designated first icon to the communication destination corresponding to the second icon displayed in the second display region.

(12) The plurality of stylized (and fixed) phrase messages includes a stylized (and fixed) phrase message (e.g., “roger”) for replying to a stylized (and fixed) phrase message from the communication destination.

(13) The plurality of stylized (and fixed) phrase messages includes a second stylized (and fixed) phrase message (e.g., “thank you”) for replying in a case of the communication destination corresponding to the transmitted stylized (and fixed) phrase message of the own device.

(14) In the case of receiving a stylized (and fixed) phrase message from the communication destination corresponding to a second icon, the display control unit 43 further displays a first icon corresponding to the received stylized (and fixed) phrase message to be associated with the second icon corresponding to the communication destination displayed in the second display region.

The same effects as the programs of (1) to (4) are thereby exerted.

### (Regarding Stylized (and Fixed) Phrase Messages Conveying Cancellation Intention)

Next, the additional function enabling a stylized (and fixed) phrase message, etc. conveying a cancellation intention will be explained. Hereinafter, the first embodiment including the additional function will be referred to as “enhanced first embodiment”.

### Stylized (and Fixed) Phrase Message Conveying Cancellation Intention

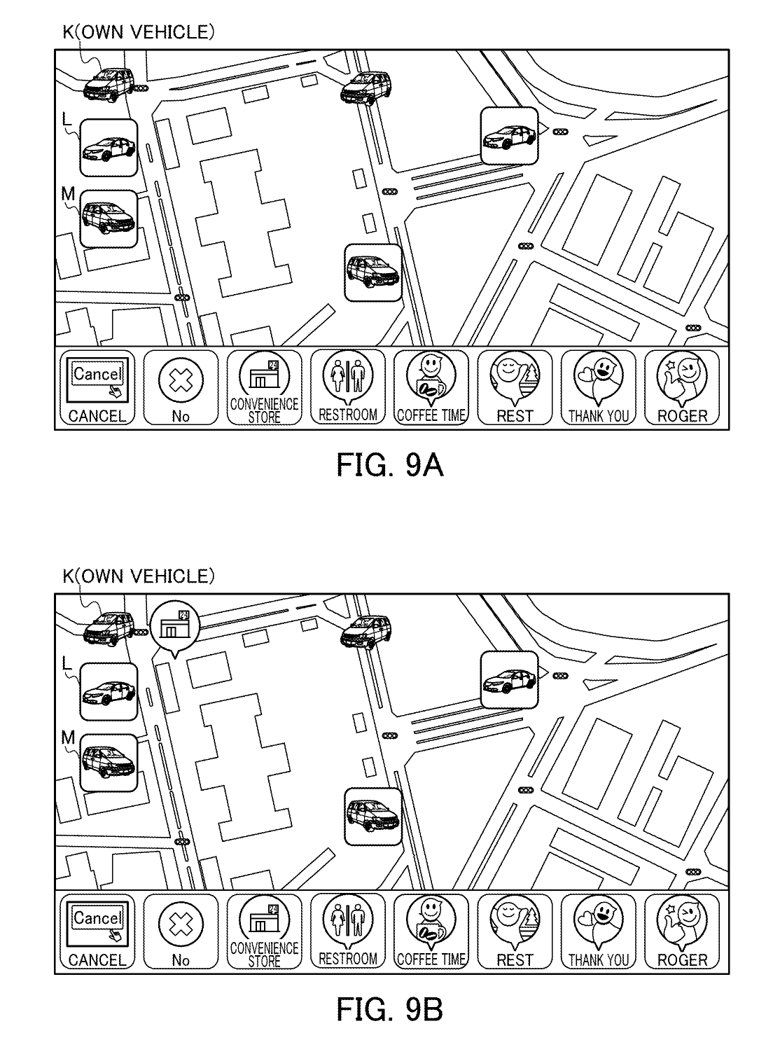

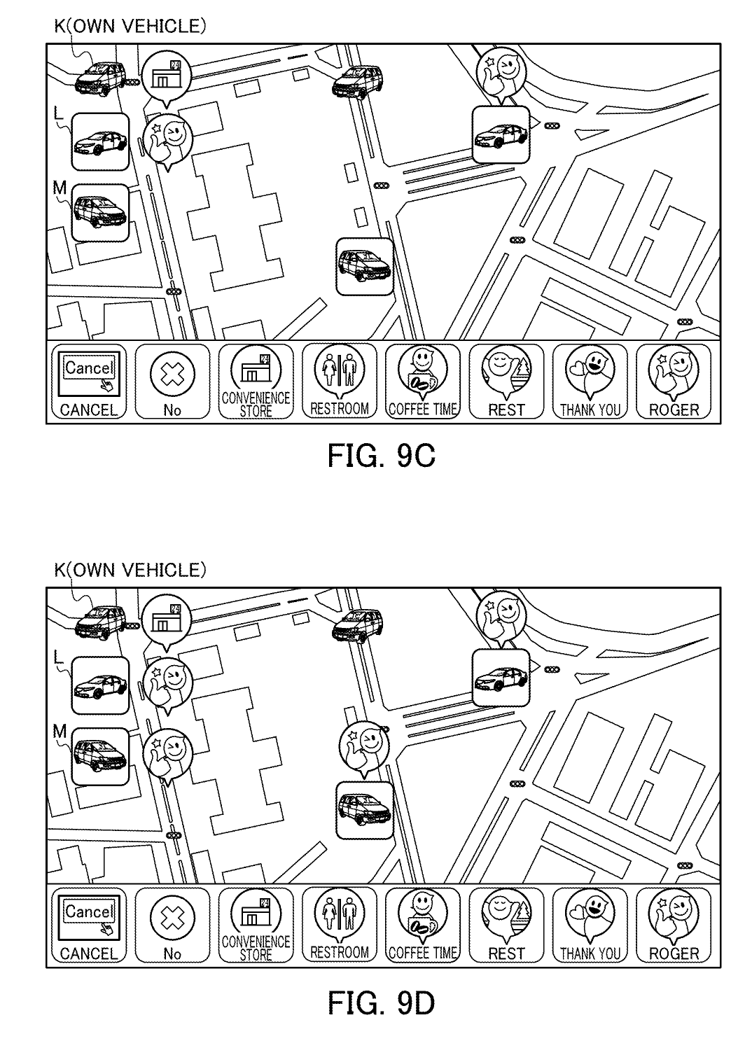

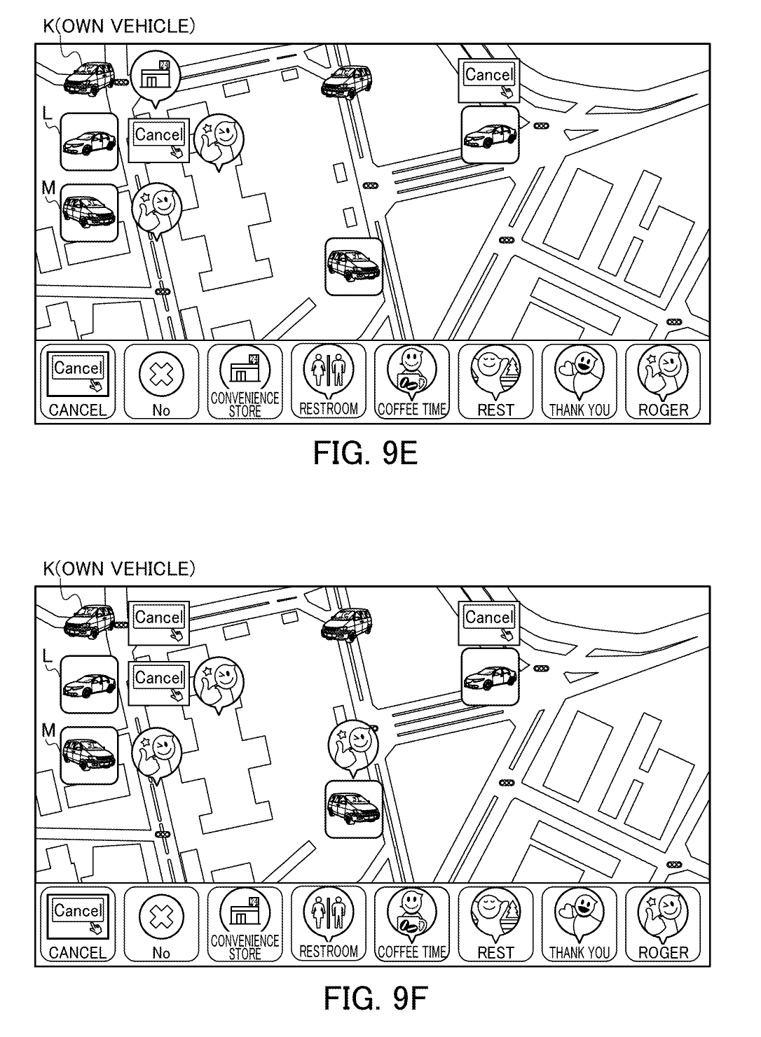

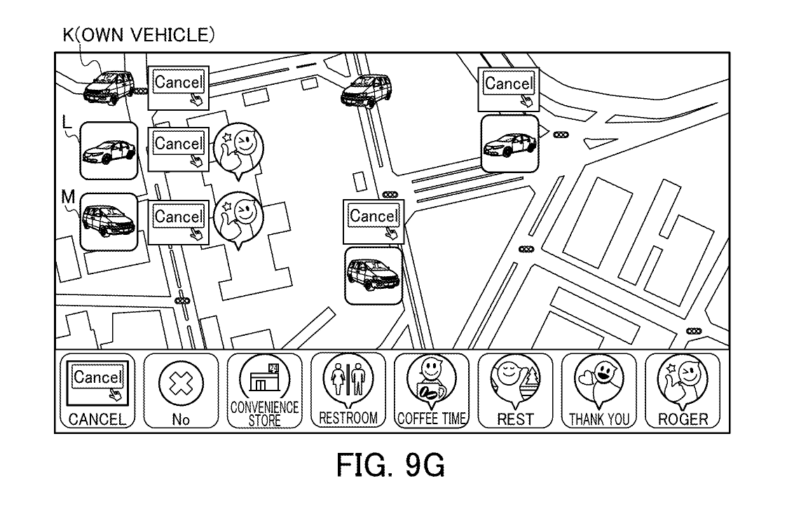

In the case of the stylized (and fixed) phrase message received from another mobile device being a stylized (and fixed) phrase message conveying the cancellation intention of a stylized (and fixed) phrase message received from this mobile device previously, it is possible to parallel display the first icon corresponding to the stylized (and fixed) phrase message serving as the cancellation target next to the first icon corresponding to the stylized (and fixed) phrase message conveying the cancellation intention as shown in FIG. 9E, for example, so as to be able to intuitively and easily confirm which stylized (and fixed) phrase message that the stylized (and fixed) phrase message conveying the cancellation intention defines as the target.

### Reply Message

Similarly, in the case of the stylized (and fixed) phrase message received from the other mobile device being a reply message (e.g., “roger”, “pending”, or “negative”) to a proposal message of (e.g., “convenience store”) from the own device or other device previously, the first icon corresponding to the proposal message serving as the reply target can be parallel displayed next to the first icon corresponding to the reply message, so that it is possible to easily determine to which proposal message the reply message is related.

It should be noted that, with the first icon corresponding to the stylized (and fixed) phrase message conveying the cancellation intention as a transparent icon simply displaying the text of “CANCEL”, for example, it may be configured so as to transparently overlay display this icon over the first icon corresponding to the stylized (and fixed) phrase message serving as the cancellation target.

Similarly, with the first icon corresponding to the reply message (e.g., “roger” or “negative”) as a transparent icon simply displaying “O” (roger) or “X” (negative), for example, it may be configured so as to transparently overlay display this icon over the first icon corresponding to the proposal message (e.g., “convenience store”) serving as the reply target.

### Display on Road Map of Stylized (and Fixed) Phrase Message Conveying Cancellation Intention

In addition, in the case of the first icon corresponding to a stylized (and fixed) phrase message conveying the cancellation intention, it is possible to parallel display the first icon corresponding to the stylized (and fixed) phrase message serving as the cancellation target next to the first icon corresponding to the stylized (and fixed) phrase message conveying the cancellation intention, similarly to the display mode of the second display region, on the currently travelled road map displayed on the display unit 11.

Alternatively, with the first icon corresponding to the stylized (and fixed) phrase message conveying the cancellation intention as a transparent icon simply displaying the text of “CANCEL”, for example, it is possible to make a configuration transparently overlap displaying this icon over the first icon corresponding to the stylized (and fixed) phrase message serving as the cancellation target.

### Display on Road Map of Reply Message

In addition, in the case of the first icon corresponding to a reply message, it is possible to parallel display the first icon corresponding to the proposal message serving as the reply target next to the first icon corresponding to the reply message, similarly to the display mode of the second display region, on the currently travelled road map displayed on the display unit 11.

Alternatively, with the first icon corresponding to the reply message (e.g., “roger” or “negative” as a transparent icon by displaying “O” (roger” or “X” (negative), for example, it is possible to make a configuration transparently overlay displaying this icon over the first icon corresponding to the proposal message (e.g., meet at convenience store”) serving as the reply target.

### Display Control Unit 43

For this reason, the display control unit 43 according to the enhanced first embodiment includes the following additional functions.

### Parallel Display

The display control unit 43 can perform parallel display, in addition to overwriting. In other words, it is configured so that the display control unit 43 can display at least two first icons, and in the case of the first icon corresponding to a message received earlier being displayed upon displaying the first icon corresponding to a message received in association with a second icon (e.g., L), the display control unit 43 can parallel display in the second region the first icon corresponding to the received message and the first icon corresponding to the message received earlier in received time information order.

Such overwriting display or parallel display can be set in advance by the information setting unit 44.

### Display of Stylized (and Fixed) Phrase Message Conveying Cancellation Intention

In the case of the stylized (and fixed) phrase message sent from the other mobile device being a stylized (and fixed) phrase message (“cancel”) conveying the cancellation intention of a stylized (and fixed) phrase message sent previously of the mobile device, the display control unit 43 can parallel display the first icon corresponding to the stylized (and fixed) phrase message serving as the cancellation target next to the first icon corresponding to the stylized (and fixed) phrase message conveying the cancellation intention, so that it can be easily determined which stylized (and fixed) phrase message is desired to be cancelled.

More specifically, in the case of information identifying which stylized (and fixed) phrase message (corresponding first icon) is desired to be cancelled being attached to the received cancellation message, the display control unit 43 can parallel display the first icon corresponding to the stylized (and fixed) phrase message serving as the cancellation target next to the first icon corresponding to the stylized (and fixed) phrase message conveying the cancellation intention, based on the information identifying which stylized (and fixed) phrase message (corresponding first icon) is desired to be cancelled.

In addition, in the case of information identifying which stylized (and fixed) phrase message (corresponding first icon) is desired to be cancelled not being attached to the received cancellation message, by referencing, from the received information history section 345, the first icon corresponding to the stylized (and fixed) phrase message received most recently from the sender sending this cancellation message, the display control unit 43 can identify which stylized (and fixed) phrase message (corresponding first icon) is desired to be cancelled, and parallel display the first icon corresponding to the stylized (and fixed) phrase message serving as the cancellation target next to the first icon corresponding to the stylized (and fixed) phrase message conveying the cancellation intention.

It should be noted that, with the first icon corresponding to the stylized (and fixed) phrase message (e.g., “cancel previous remark”) conveying the cancellation intention as a transparent icon simply displaying the text “CANCEL”, for example, the display control unit 43 may transparently overlay display this icon over the first icon corresponding to the stylized (and fixed) phrase message serving as the cancellation target.

By configuring in this way, it is no longer necessary to ensure a region to parallel display in the second display unit. In addition, by displaying the first icon to be transparently overwritten displayed, the user can intuitively and easily confirm the contents of the stylized (and fixed) phrase message conveying the cancellation intention.

### Display of Reply Message

In the case of a message sent from the other mobile device being a reply message (e.g., “roger”, “pending”, or “negative”) to a proposal message (e.g., “convenience store”) from the own vehicle 1 or other vehicle, etc., the display control unit 43 can parallel display the first icon corresponding to the stylized (and fixed) phrase message serving as a reply target next to the first icon corresponding to the reply message, so that it is possible to easily determine to which proposal message the reply message is related.

More specifically, in the case of information identifying to which stylized (and fixed) phrase message (corresponding first icon) a received reply message corresponds being attached to this reply message, the display control unit 43 can parallel display a first icon corresponding to a stylized (and fixed) phrase message serving as the reply target next to the first icon corresponding to the reply message, based on the information identifying to which stylized (and fixed) phrase message (corresponding first icon) it corresponds.

In addition, in the case of information identifying to which stylized (and fixed) phrase message (corresponding first icon) a received reply message corresponds not being attached to this reply message, by referencing, from the sent information history section 341, the first icon corresponding to the stylized (and fixed) phrase message (proposal) sent most recently to the communication destination sending this reply message, the display control unit 43 can identify to which stylized (and fixed) phrase message (corresponding first icon) this reply message corresponds, and parallel display a first icon corresponding to a stylized (and fixed) phrase message serving as the reply target next to the first icon corresponding to this reply message.

It should be noted that, with the first icon corresponding to the reply message (e.g., “roger” or “negative”) as a transparent icon simply displaying “O” (roger) or “X” (negative), for example, the display control unit 43 may transparently overlay display this icon over the first icon corresponding to the stylized (and fixed) phrase message (e.g., “convenience store”) serving as the reply target.

By configuring in this way, it is no longer necessary to ensure a region to parallel display in the second display unit. In addition, by displaying the first icon to be transparently overlay displayed, the user can intuitively and easily confirm the contents of the reply message.

### Regarding Information Setting Unit 44

In addition, the information setting unit 44 related to the enhanced first embodiment includes the following additional functions.

The information setting unit 44 sets whether to overwrite display or parallel display the first icon on the currently travelled road map displayed in the second display region or on the display unit 11.

According to the settings of the information setting unit 44, the display control unit 43, in the case of the first icon corresponding to a stylized (and fixed) phrase message conveying a cancellation intention, can parallel display the first icon corresponding to the stylized (and fixed) phrase message serving as the cancellation target next to the first icon corresponding to the stylized (and fixed) phrase message conveying the cancellation intention, similarly to the display mode in the above-mentioned second display region, on the currently travelled road map displayed on the display unit 11.

Alternatively, with the first icon corresponding to the stylized (and fixed) phrase message conveying the cancellation intention as a transparent icon simply displaying the text of “CANCEL”, for example, it can be made a configuration that transparently overlay displays this icon over the first icon corresponding to the stylized (and fixed) phrase message serving as the cancellation target.

Similarly, according to the settings of the information setting unit 44, in the case of the first icon corresponding to a reply message, the display control unit 43 can parallel display the first icon corresponding to the proposal message serving as the reply target next to the first icon corresponding to the reply message, similarly to the display mode of the above-mentioned second display region, on the currently travelled road map displayed on the display unit 11.

Alternatively, with the first icon corresponding to a reply message (e.g., “roger” or “negative”) as a transparent icon simply displaying “O” (roger) or “X” (negative), for example, it is possible to make a configuration that transparently overlay displays this icon over the first icon corresponding to the proposal message (e.g., “meet at convenience store”) serving as the reply target.

It should be noted that, as shown in FIG. 9C, for example, the display control unit 43 may be configured so as to display only the first icon corresponding to a newest message, for the first icons associated with a second icon corresponding to a communicable other mobile device, displayed on the road map.

### Regarding Message Processing Unit 45

In addition, the message processing unit 45 related to the enhanced first embodiment includes the following additional functions.

### Regarding Creation of Stylized (and Fixed) Phrase Message

In response to at least one second icon being selected from the second icons identifying currently communicable mobile devices displayed in the second display region of the display unit 11 by way of a tap operation of the user, for example, and one first icon being selected from the list of a plurality of first icons displayed in the first display region, the message processing unit 45 sends a stylized (and fixed) phrase message corresponding to the first icon selected to the mobile device corresponding to the selected second icon, via the wireless communication unit 20.

At this time, the message processing unit 45 stores this sent information in the sent information history section 344 as log information.

The message processing unit 45 stores the above-mentioned information sent to this mobile device in the sent information history section 341.

It should be noted that, in the case of being set by the information setting unit 44 so that the second icon corresponding to the own device is displayed in the second display region, the display control unit 43 displays the first icon corresponding to the above-mentioned stylized (and fixed) phrase message sent by the own device in the second display region to be associated with the second icon corresponding to the own device displayed in the second display region.

### Sending of Same Message to Plurality of Mobile Devices

In the case of the user selecting a plurality of second icons from the second display region, and selecting a first icon from the first display region, the message processing unit 45 can send the stylized (and fixed) phrase message corresponding to the selected first icon, etc. to each of the mobile devices corresponding to the plurality of second icons selected. By configuring in this way, it is possible to simply make the operation to send the same stylized (and fixed) phrase message to a plurality of mobile devices.

In addition, the message processing unit 45 can broadcast the selected stylized (and fixed) phrase message according to an instruction of broadcast by the user, via the information sending unit 22.

### Sending of Stylized (and Fixed) Phrase Message Conveying Cancellation Intention

In the case of the first icon selected by the user from the first display region corresponding to a stylized (and fixed) phrase message conveying a cancellation intention, the message processing unit 45 searches, from the sent information history section 344, for the identification ID of the first icon corresponding to the stylized (and fixed) phrase message most recently sent to the mobile device corresponding to the second icon selected by the user from the second display region, creates a communication record in which the identification ID of the first icon corresponding to the stylized (and fixed) phrase message most recently sent is added to the identification ID of the first icon corresponding to the stylized (and fixed) phrase message conveying the cancellation intention, and sends to the mobile device corresponding to the selected second icon via the information sending unit 22.

By configuring in this way, the mobile device receiving this communication record can easily determine which stylized (and fixed) phrase message is desired to be cancelled.

It should be noted that, in the case of being set by the information setting unit 44 so as to display the second icon corresponding to the own device in the second display region, it is possible to create and send a stylized (and fixed) phrase message conveying the cancellation intention as follows.

In the case of first selecting the first icon corresponding to the newest message sent by the own device displayed in the second display region, and subsequently selecting the first icon corresponding to the stylized (and fixed) phrase message conveying a cancellation intention from the first display region, a communication record is created in which the identification ID of the first icon corresponding to the newest message sent by the own device selected first is added to the identification ID of the first icon corresponding to the stylized (and fixed) phrase message conveying the cancellation intention, and is sent to the communication destination of the first icon corresponding to the newest message sent by the own device via the information sending unit 22.

For example, as shown in FIG. 9E, in the case of selecting the first icon (“convenience store”) corresponding to the newest message sent by the own device, and selecting the first icon corresponding to the stylized (and fixed) phrase message conveying the cancellation intention from the first display region, it is possible to send a communication record in which the identification ID of the first icon (“convenience store”) is added to the identification ID of the first icon corresponding to the stylized (and fixed) phrase message conveying the cancellation intention, to the mobile device (L) and the mobile device (M).

### Sending of Reply Message

In the case of the first icon selected by the user from the first display region corresponding to the reply message such as “roger”, for example, the message processing unit 45 searches the received information history section 345 for the identification ID of the first icon corresponding to the stylized (and fixed) phrase message (proposal) most recently received, from the mobile device corresponding to the second icon selected by the user from the second display region. Then, a communication record is created in which the identification ID of the first icon corresponding to the stylized (and fixed) phrase message (proposal) most recently received is added to the identification ID of the first icon corresponding to the reply message, and sent to the mobile device corresponding to the selected second icon via the information sending unit 22.

By configuring in this way, the mobile device receiving this communication record can easily determine to which stylized (and fixed) phrase message (proposal) the reply message relates.

It should be noted that it is possible to create and send reply messages in the following way.

In the case of the first icon corresponding to the stylized (and fixed) phrase message (proposal) displayed in the second display region being selected first by the user, and subsequently, the first icon corresponding to a reply message being selected from the first display region, the message processing unit 45 creates a communication record in which the identification ID of the first icon corresponding to the stylized (and fixed) phrase message (proposal) selected first is added to the identification ID of the first icon corresponding to the reply message. Then, it is sent to the sender of this stylized (and fixed) phrase message (proposal) via the information sending unit 22.

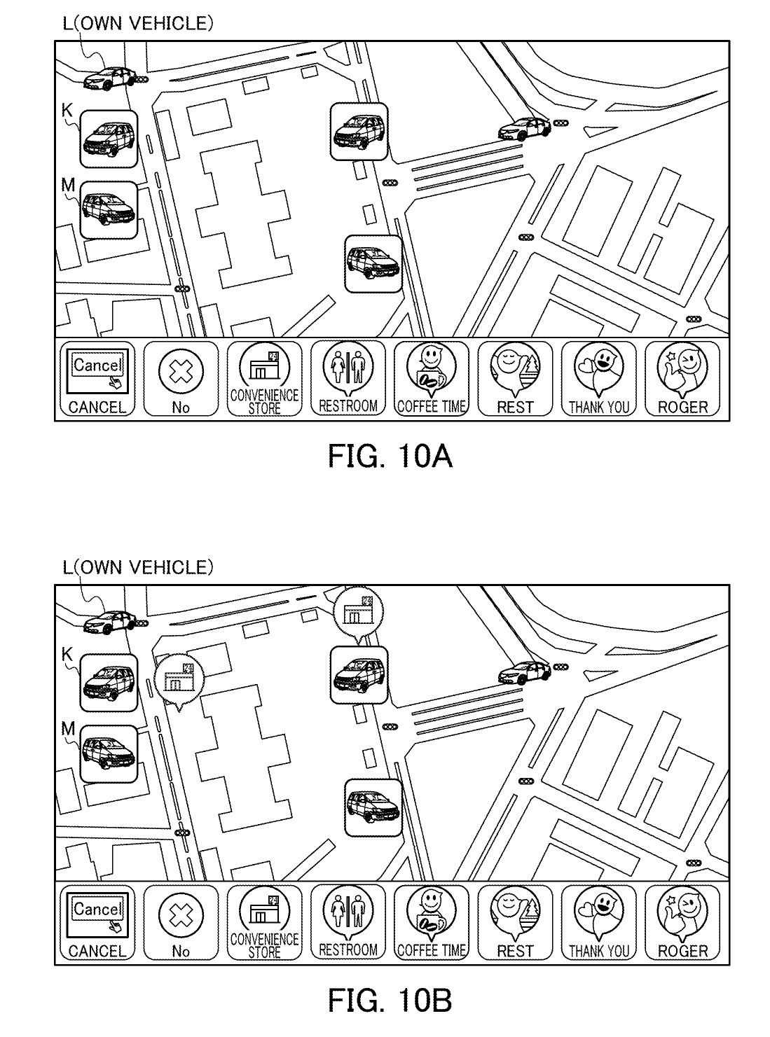

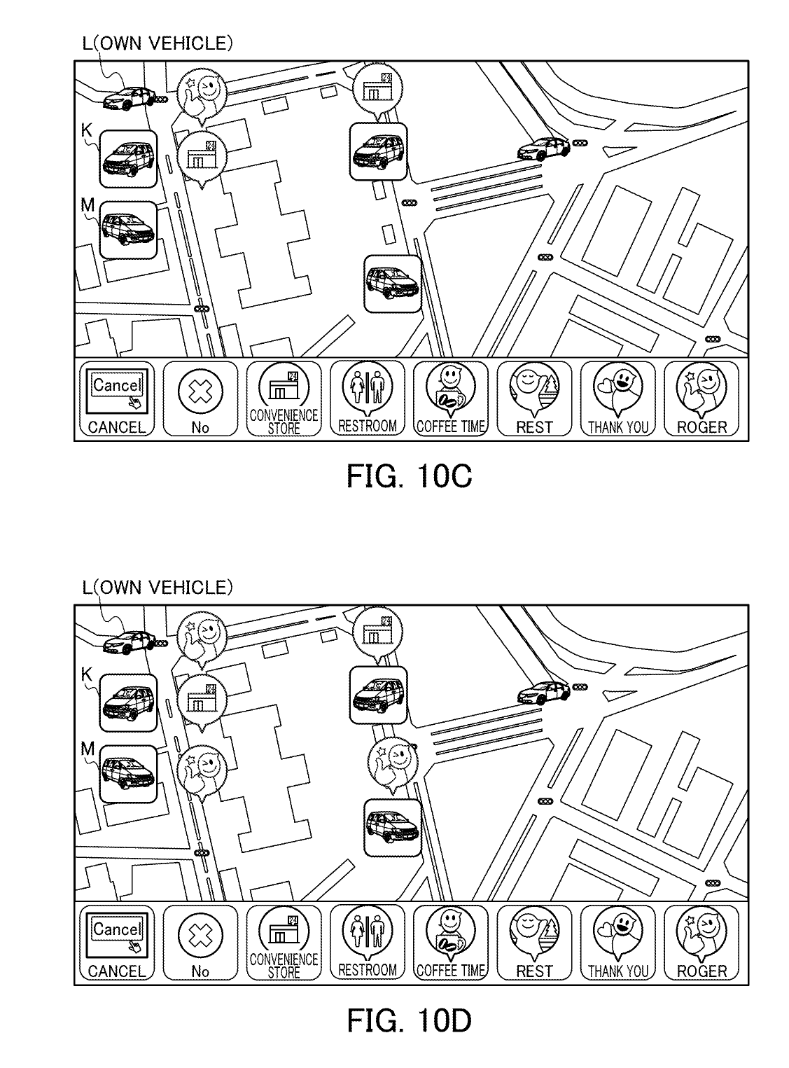

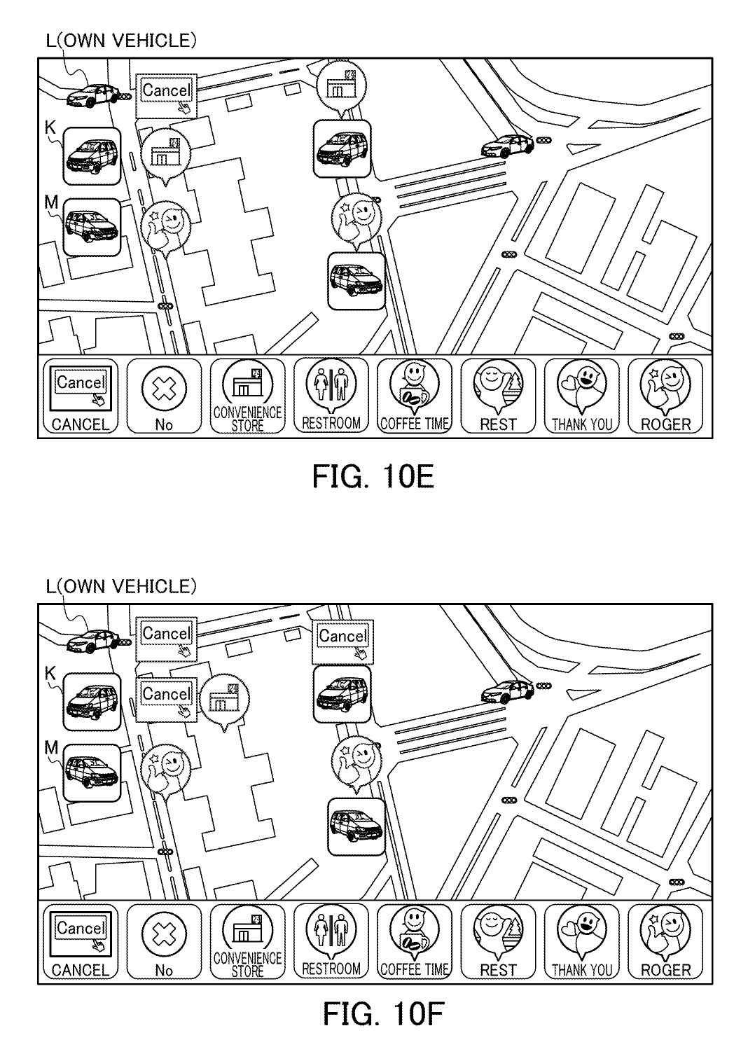

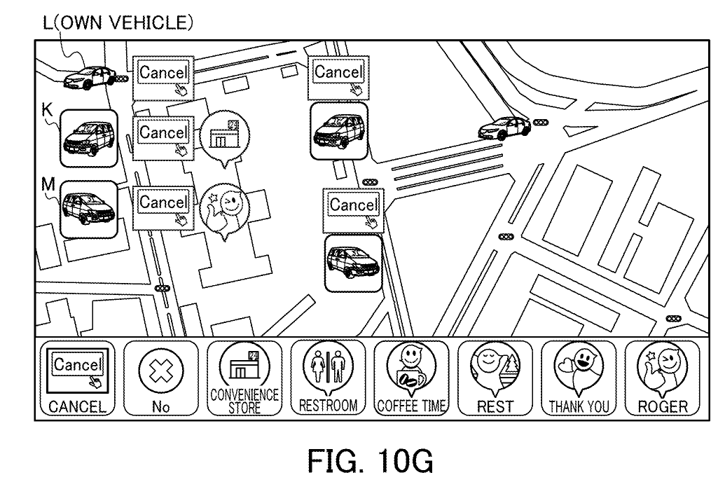

For example, as shown in FIG. 10B, in the case of the first icon (“convenience store”) corresponding to the stylized (and fixed) phrase message (proposal) received from the mobile device (K) being selected by the user, and the first icon (“roger”) corresponding to a reply message being selected from the first display region, the message processing unit 45 can send a communication record in which the identification ID of the first icon (“convenience store”) is added to the identification ID of the first icon (“roger”) to the mobile device (K).

### (Regarding Operations of Electronic Device 2)

Next, the operations of the electronic device 2 according to the enhanced first embodiment will be explained by referencing FIGS. 9A to 9G and 10A to 10G. These show examples of a case of the mobile device (K), mobile device (L) and mobile device (M) all doing message exchange while moving.

FIGS. 9A to 9G show display screens displayed on the mobile device (K).

FIGS. 10A to 10G show display screens displayed on the mobile device (L).

It should be noted that in order to facilitate understanding of the explanation, FIGS. 9A to 9G and FIGS. 10A to 10G are screen display examples for a case of setting by the information setting unit 44 so as to display the second icon corresponding to the own device in the second display region.

It should be noted that the display screen displayed on the electronic device 2 in the case of being set so as not to display the second icon corresponding to the own device in the second display region can be explained by reading as drawings in which the own device (K) is not displayed for FIGS. 9A to 9G, and as drawings in which the own device (L) is not displayed for FIGS. 10A to 10G.

First, the mobile device (K), mobile device (L) and mobile device (M) enter a communicable state. In FIGS. 9A and 10A, the display control unit 11 is displaying that the mobile device (K), mobile device (L) and mobile device (M) are in a connected state.

Herein, as shown in FIG. 9A, in response to the second icon (L) and second icon (M) displayed in the second display region being selected by the user (K) of the mobile device (K), and the first icon (“convenience store”) being selected from the list of first icons displayed in the first display region, the message processing unit 45 sends the identification ID of the first icon (“convenience store”), time information, GPS information, etc. to the mobile device (L) and mobile device (M).

By configuring in this way, the user (K) of the mobile device (K) can make a “convenience store” proposal to the members of the group easily.

As shown in FIG. 9B, the first icon (“convenience store”) is displayed in the second display region to be associated with the second icon (K) of the own device by the display control unit 43.

As shown in FIG. 10B, it is displayed that the “convenience store” proposal message arrived from the mobile device (K) on the mobile device (L). The first icon (“convenience store”) is displayed in the second display region to be associated with the second icon (K) of the second display region, as well as the first icon (“convenience store”) being displayed to be associated with the second icon (K) displayed on the currently travelled road map.

By configuring in this way, the user (L) of the mobile device (L) can intuitively and easily understand that there was a “convenience store” proposal from the mobile device (K).

In response to the second icon (K) and second icon (M) displayed in the second display region being selected by the user (L) of the mobile device (L), and the first icon (“roger”) being selected from the list of first icons displayed in the first display region, the message processing unit 45 sends the identification ID of the first icon (“roger”), time information, GPS information, etc. to the mobile device (K) and mobile device (M).

By configuring in this way, the user (L) of the mobile device (L) can make a “roger” reply to the members of the group easily.

As shown in FIG. 10C, it is displayed on the electronic device 2 of the mobile device (L) that the “roger” message was sent.

As shown in FIG. 9C, it is displayed on the mobile device (K) that the “roger” message arrived from the mobile device (L). The first icon (“roger”) is displayed in the second display region to be associated with the second icon (L) of the second display region, as well as the first icon (“roger”) being displayed to be associated with the second icon (L) displayed on the currently travelled road map.

By configuring in this way, the user (K) of the mobile device (K) intuitively and easily understands the matter of “roger” being made from the mobile device (L).

Similarly, in response to the second icon (K) and second icon (L) displayed in the second display region being selected by the user (M) of the mobile device (M), and the first icon (“roger”) being selected from the list of first icons displayed in the first display region, the message processing unit 45 sends the identification ID of the first icon (“roger”), time information, GPS information, etc. to the mobile device (K) and mobile device (L).

As shown in FIG. 9D, the matter of the “roger” message having arrived from the mobile device (M) is displayed on the mobile device (K). Similarly, as shown in FIG. 10D, the matter of the “roger” message having arrived from the mobile device (M) is displayed on the mobile device (L).

Herein, in response to the second icon (K) and second icon (M) displayed in the second display region being selected by the user (L) of the mobile device (L), and the first icon (“cancel”) being selected from the list of first icons displayed in the first display region, the message processing unit 45 sends the identification ID of the first icon (“cancel”), time information, GPS information, etc. to the mobile device (K) and mobile device (M).

By configuring in this way, the user (L) of the mobile device (L) can communicate “cancel” to the members of the group easily.

As shown in FIG. 10E, the matter of a “cancel” message being sent is displayed on the mobile device (L).

As shown in FIG. 9E, the matter of the “cancel” message having arrived from the mobile device (L) is displayed on the mobile device (K). In other words, the first icon (“cancel”) and the first icon (“roger”) serving as the cancel target are parallel displayed in the second display region to be associated with the second icon (L) of the second display region.

By configuring in this way, the user (K) of the mobile device (K) can easily understand that the “roger” is cancelled from the user (L) of the mobile device (L).

Therefore, in response to the second icon (L) and second icon (M) displayed in the second display region being selected by the user (K) of the mobile device (K), and the first icon (“cancel”) being selected from the list of first icons displayed in the first display region, the message processing unit 45 sends the identification ID of the first icon (“cancel”), time information, GPS information, etc. to the mobile device (L) and mobile device (M).

By configuring in this way, the user (K) of the mobile device (K) can convey the cancellation intention of the “convenience store” proposal to the members of the group easily.

As shown in FIG. 9F, the matter of the “cancel” message being sent is displayed on the mobile device (K).

As shown in FIG. 10F, the matter of a “cancel” message having arrived from the mobile device (K) is displayed on the mobile device (L). In other words, the first icon (“cancel”) and the first icon (“convenience store”) serving as the cancellation target are parallel displayed in the second display region to be associated with the second icon (K) of the second display region.

By configuring in this way, the user (L) of the mobile device (L) can easily understand that the “convenience store” proposal was cancelled from the user (K) of the mobile device (K).

Similarly, the matter of the “cancel” message having arrived from the mobile device (K) is also displayed on the mobile device (M).

Similarly, in response to the second icon (K) and second icon (L) displayed in the second display region being selected by the user (M) of the mobile device (M), and the first icon (“cancel”) being selected from the list of first icons displayed in the first display region, the message processing unit 45 sends the identification ID of the first icon (“cancel”), time information, GPS information, etc. to the mobile device (K) and the mobile device (L).

By configuring in this way, the user (M) of the mobile device (M) can communicate “cancel” to the members of the group, easily.

As shown in FIG. 9G, the matter of the “cancel” message having arrived from the mobile device (M) is displayed on the mobile device (K).

Similarly, as shown in FIG. 10G, the matter of the “cancel” message having arrived from the mobile device (M) is displayed on the mobile device (L).

As shown above, it is possible to communicate between cars while travelling by using the communication information of the present invention.

### Regarding Other Additional Functions

Next, other additional functions of the enhanced first embodiment will be explained.

### Regarding First Icon

As shown in FIG. 9A, for example, a list of first icons corresponding to selectable stylized (and fixed) phrase messages is displayed in a predetermined display region (hereinafter also referred to as “first display region”) provided at a lower side, for example, on the display unit 11.

The list of selectable first icons is not limited to the size of the screen of the display unit 11.

In addition, as shown in FIG. 6, the menu button at the left end serves as a switching button, and it is possible to configure so as to perform switching between a plurality of menus by depressing the menu button. With the button at the end of the menu bar which consists of a plurality of first icons as a menu button in FIG. 6, it may be configured to perform switching between a plurality of menu bars by depressing the menu button.

By providing a plurality of lists of selectable first icons (menu bars), and making switchable between menu bars and scrollable, the number of selectable stylized (and fixed) phrase messages is not limited to the size of the screen of the display unit 11.

In addition, by making a slide operation in the transverse direction with a finger contacting the first display region, it may be made so as to cause the list of first icons displayed on the first display region to scroll in the transverse direction.

It should be noted that the first display region is not limited to the lower side on the display unit 11, and as a modified example, can be established at a predetermined position, such as the upper side, for example, on the display unit 11.

In addition, it may be configured so as to rearrange the first icons according to the frequency of use by the user or use situation.

In this way, by establishing the list display of first icons (menu bar display) as appropriate in response to the use situation of the user, it is possible to improve the user friendliness.

### Regarding User Unique Messages, Etc.

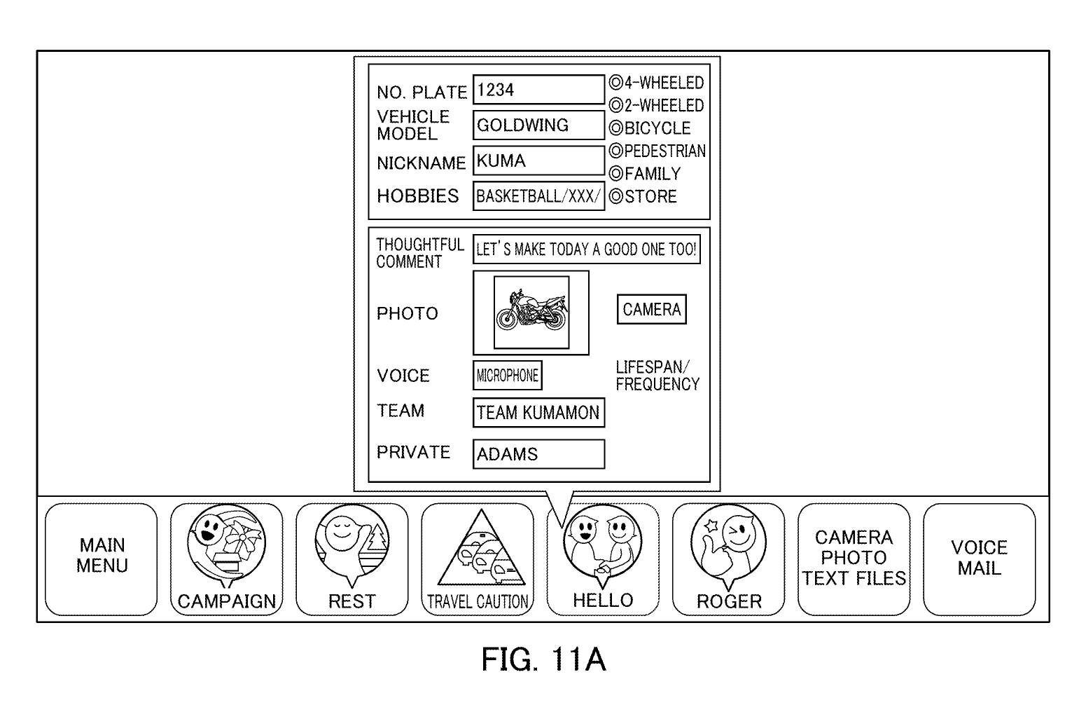

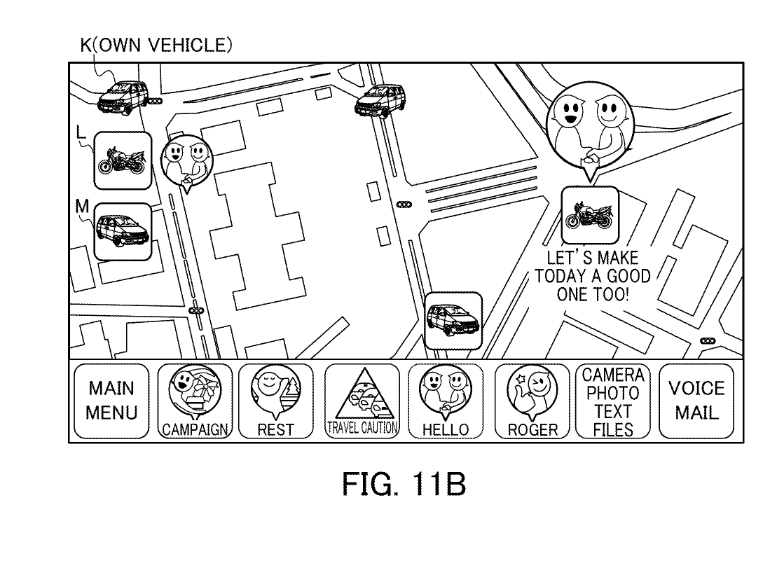

The information setting unit 44 can additionally set (customize) a user unique message to the stylized (and fixed) phrase messages according to the instruction of the user, as shown in FIG. 11A.

In this case, the unique message is displayed in the vicinity of the second icon by the display control unit 43, as shown in FIG. 11B.

In addition, the information setting unit 44 can customize the second icon for displaying the user, as shown in FIG. 11A.

It should be noted that in a case of the user customizing the data of the second icon by way of the information setting unit 44 the data of a customized second icon is included in a connection request and a connection confirmation sent and received by the connection processing unit 42.

More specifically, for example, it is processed as follows.

From the communication record of the own device address received via the information receiving unit 21 from the communicable other mobile device (L), the connection processing unit 42 extracts the identification ID of the second icon corresponding to the mobile device (L) of the sender, data of the second icon, the identification ID of the first icon corresponding to the stylized (and fixed) phrase message sent from the sender, message customized by the user, time information, GPS information of the mobile device of the sender, etc.

In addition, the message processing unit 45 acquires the communication address information (e.g., IP address, MAC address, etc.) of the mobile device corresponding to a selected second icon, etc. from the connection table 343; creates a communication record setting this communication address as the communication destination address, setting the communication address of the own device as the sender address, and setting the identification ID of the second icon corresponding to the own device, data of the second icon, identification ID of the first icon corresponding to the selected stylized (and fixed) phrase message, message customized by user, time information, GPS information of the own device, etc. in the sent data buffer; and then sends to the mobile device corresponding to the selected second icon via the information sending unit 22.

In the case of being customized by the user in this way, the “data of second icon” and “message customized by user” are included in the communication record.

The user unique message is useful in the case of an electronic device equipped to, for example, roadside communication equipment along the road, facilities along the road, stores along the road, etc. For example, a store along the road can additionally customize specific information such as coupon information, discount information and big bargain sale information in a stylized (and fixed) phrase message in advance by way of the information setting unit 44. Then, the store along the road can effectively appeal, at fixed intervals, to vehicles traveling on the road, by transmitting towards the road a stylized (and fixed) phrase message in which specific information such as coupon information, discount information and big bargain sale information has been additionally customized in advance. It should be noted that it is useful to also include homepage address URL of this store in the communication information as the additional customized information.

It is also possible for public facilities along the road to effectively appeal to vehicles traveling on the road, by transmitting towards the road a stylized (and fixed) phrase message in which specific information such as special event information and sightseeing information of this area is additionally customized in advance.

### Example of Other Communication Information

By drawing an advertisement on a traveling vehicle, the advertisement demonstration vehicle traveling on the road can be seen; however, the advertisement demonstration vehicle may want to convey the advertisement also to surrounding vehicles in this way.

In such a case, by sending advertisement information (e.g., information in which user unique message has been added to a stylized (and fixed) phrase message) of the advertisement demonstration vehicle as the communication information, it is possible for surrounding vehicles to receive this communication information and the surrounding vehicles be made to display this message.

### Facility Along Road, or Store Along Road

A facility along the road or store along the road (not illustrated) can include business-type information of the facility or store in the communication information, upon transmission of the communication information. By a vehicle passing the breadth of the facility or store priority setting the business type of convenience store in advance, for example, it can be configured so that the display control unit 43 further emphasizes being a stylized (and fixed) phrase message expressing communication information from a convenience store, upon the display of stylized (and fixed) phrase messages (e.g., bargain sales, coupon services, etc.). By configuring in this way, the driver of the own vehicle 1 can easily detect the advertisement information of a convenience store that is along the road.

### Roadside Communication Equipment Along Road

Roadside communication equipment along the road (not illustrated) can transmit that there is a stylized (and fixed) phrase message (e.g., message adding a user unique message to a stylized (and fixed) phrase message) related to important traffic information such as traffic delay information, for example, to vehicles traveling on this road. By configuring in this way, the own device 1 travelling on the road can display on the display unit 11 of the electronic device 2 inside of the own vehicle 1, when approaching the roadside communication equipment along the road.

The following such effects are exerted by the program, method and electronic device 2 for performing stylized (and fixed) phrase message exchange of the enhanced first embodiment explained above.

(1) In the enhanced first embodiment, the program for performing stylized (and fixed) phrase message exchange is a program for causing the electronic device 2 including the wireless communication unit 20 and display unit 11 to function as: the display control unit 43 that displays a second icon corresponding to a communication destination in the second display region of the display unit 11 and displays a plurality of first icons corresponding to a plurality of stylized (and fixed) phrase messages in the first display region of the display unit 11; and a message processing unit that, in response to at least one second icon and one first icon being designated in a state in which a second icon corresponding to a communication destination is being displayed in the second display region and a plurality of first icons are being displayed in the first display region, sends the stylized (and fixed) phrase message corresponding to the first icon designated to the communication destination corresponding to the second icon designated, via the wireless communication unit 20, in which the plurality of stylized (and fixed) phrase messages includes at least one predetermined stylized (and fixed) phrase message that can reference a sent stylized (and fixed) phrase message.

(2) At least one predetermined stylized (and fixed) phrase message is a stylized (and fixed) phrase message conveying a cancellation intention of a sent stylized (and fixed) phrase message.

By stylizing a message having high frequency of use and associating this to a first icon, from creation to transmission of the message is automatically processed by simply selecting the corresponding first icon. In addition, in the case of sending a message mistakenly, or a case of wanting to cancel a proposal already sent, by simply associating to a first icon associated with the stylized (and fixed) phrase message conveying a cancellation intention, from creation to transmission of the stylized (and fixed) phrase message conveying the cancellation intention is automatically processed.

It is thereby possible for the driver, etc. of an automobile, etc. to intuitively and easily perform in a short time the sending operation of a stylized (and fixed) phrase message having high frequency of use while traveling, and in the case of sending a stylized (and fixed) phrase message mistakenly, or in a case of wanting to cancel a proposal already sent, perform a stylized (and fixed) phrase message conveying the cancellation intention, whereby movement of the point of view while travelling is suppressed, and smooth communication can be achieved.

(3) The program for performing stylized (and fixed) phrase message exchange of the enhanced first embodiment causes the electronic device 2 to function so that the display control unit 43, in response to receiving a stylized (and fixed) phrase message from the communication destination corresponding to the second icon via the wireless communication unit 20, displays a first icon corresponding to the stylized (and fixed) phrase message received in the second display region of the display unit 11 to be associated with the second icon corresponding to the communication destination displayed in the second display region.

(4) The program for performing stylized (and fixed) phrase message exchange of the enhanced first embodiment causes the electronic device 2 to function so that the display control unit 43, upon further displaying a first icon corresponding to the received stylized (and fixed) phrase message to be associated with a second icon in the second display region, in the case of a first icon corresponding to a stylized (and fixed) phrase message previously received being displayed, overwrites the first icon corresponding to the received stylized (and fixed) phrase message over the first icon corresponding to the stylized (and fixed) phrase message previously received.

It is thereby possible to display by associating a first icon corresponding to the newest message information for every second icon corresponding to a message sender.

(5) The program for performing stylized (and fixed) phrase message exchange of the enhanced first embodiment causes the electronic device 2 to function so that, in the case of the stylized (and fixed) phrase message corresponding to the designated first icon being a predetermined stylized (and fixed) phrase message, the message processing unit 45 further sends to the communication destination corresponding to the designated second icon by adding information identifying the first icon corresponding to the stylized (and fixed) phrase message most recently sent to the communication destination corresponding to the designated second icon, to the stylized (and fixed) phrase message corresponding to the designated first icon; and the display control unit 43, in the case of the received stylized (and fixed) phrase message being a predetermined stylized (and fixed) phrase message, further displays the second icon corresponding to the communication destination in the second display region, as well as displaying the first icon corresponding to the received predetermined stylized (and fixed) phrase message to be associated with the second icon, and displays the first icon identified by the information added to the predetermined stylized (and fixed) phrase message.

(6) The program for performing stylized (and fixed) phrase message exchange of the enhanced first embodiment causes the electronic device 2 to function so that, in the case of a received stylized (and fixed) phrase message being a predetermined stylized (and fixed) phrase message, the display control unit 43 further displays a first icon corresponding to the received stylized (and fixed) phrase message in the second display region, as well as displaying a first icon corresponding to the stylized (and fixed) phrase message received most recently from the communication destination corresponding to the second icon.

It is thereby possible for the sender creating the stylized (and fixed) phrase message conveying the cancellation intention to cancel a most recent message by simply an operation of selecting a first icon corresponding to the stylized (and fixed) phrase message conveying the cancellation intention. In addition, the receiver of the stylized (and fixed) phrase message conveying the cancellation intention can intuitively and easily confirm which message the stylized (and fixed) phrase message conveying the cancellation intention set as the target.

(7) The program of the enhanced first embodiment causes the display control unit 43, in the case of a first icon corresponding to the stylized (and fixed) phrase message previously received being displayed upon displaying the first icon corresponding to a received stylized (and fixed) phrase message to be associated with the second icon, to further function as a display control unit that displays, in the second display region in the received time information order, the first icon corresponding to the received stylized (and fixed) phrase message and the first icon corresponding to stylized (and fixed) phrase message previously received.

It is thereby possible to intuitively and easily confirm in a chronological manner the newest message received from a communication destination that is currently communicable and the most recent messages prior thereto.

(8) The method for the electronic device 2 including the wireless communication unit 20 and display unit 11 to perform stylized (and fixed) phrase message exchange of the enhanced first embodiment includes: a display control step of displaying a second icon corresponding to a communication destination in the second display region of the display unit 11, and displaying a plurality of first icons corresponding to a plurality of stylized (and fixed) phrase messages in the first display region of the display unit 11; and a message processing step of, in response to at least one second icon and one first icon being designated in a state in which a second icon corresponding to the communication destination is being displayed in the second display region and the plurality of first icons is being displayed in the first display region, sending a stylized (and fixed) phrase message corresponding to the first icon designated to the communication destination corresponding to the second icon designated via the wireless communication unit 20, in which the plurality of stylized (and fixed) phrase messages includes at least one predetermined stylized (and fixed) phrase message that can refer to a sent stylized (and fixed) phrase message.

(9) At least one predetermined stylized (and fixed) phrase message is a stylized (and fixed) phrase message conveying a cancellation intention of a sent stylized (and fixed) phrase message.

(10) The method for the electronic device 2 including the wireless communication unit 20 and display unit 11 to perform stylized (and fixed) phrase message exchange of the enhanced first embodiment further includes a step of displaying a first icon corresponding to a stylized (and fixed) phrase message received in the second display region of the display unit 11 to be associated with the second icon corresponding to the communication destination displayed in the second display region, based on having received the stylized (and fixed) phrase message from the communication destination corresponding to the second icon via the wireless communication unit 20.

The same effects are thereby exerted as (1) to (3) of the program.

(11) The electronic device 2 of the enhanced first embodiment includes: the display control unit 43 that displays a plurality of first icons corresponding to a plurality of stylized (and fixed) phrase messages in the first display region of the display unit 11; and the message processing unit 45 that, in response to at least one second icon and one first icon being designated in a state in which a second icon corresponding to the communication destination being displayed in the second display region and a plurality of first icons being displayed in the first display region, sends a stylized (and fixed) phrase message corresponding to the first icon designated to the communication destination corresponding to the second icon designated, via the wireless communication unit 20, in which the plurality of stylized (and fixed) phrase messages includes at least one predetermined stylized (and fixed) phrase message that can reference a sent stylized (and fixed) phrase message.

(12) The at least one predetermined stylized (and fixed) phrase message is a stylized (and fixed) phrase message conveying a cancellation intention of a sent stylized (and fixed) phrase message.

(13) The display control unit 43 of the electronic device 2 of the enhanced first embodiment displays a first icon corresponding to a received stylized (and fixed) phrase message in the second display region of the display unit 11 to be associated with the second icon corresponding to the communication destination displayed in the second display region, based on having received a stylized (and fixed) phrase message from the communication destination corresponding to the second icon via the wireless communication unit 20.

The same effects are thereby exerted as (1) to (3) of the program.

Although preferred embodiments of the present invention have been explained in the foregoing, the present invention is not to be limited to the aforementioned embodiments, and can be modified as appropriate.

### EXPLANATION OF REFERENCE NUMERALS

1 own vehicle
2 electronic device
11 display unit
12 speaker
13 microphone
14 operation unit
15 camera
20 wireless communication unit
21 information receiving unit
22 information sending unit
31 GPS processing unit
32 storage unit
341 second icon list
342 stylized (and fixed) phrase message list
343 connection table
344 sent information history section
345 received information history section
40 control unit
41 current position calculation unit
42 connection processing unit
43 display control unit
44 information setting unit
45 message processing unit

1. A method for an electronic device including a wireless communication unit and a display unit to exchange messages according to stylized and fixed mark/picture/graphic with a communication destination, the method comprising the steps of:
displaying a plurality of first icons corresponding to a plurality of messages according to stylized and fixed mark/picture/graphic in a first display region of the display unit, and displaying a second icon corresponding to the communication destination in a second display region of the display unit; and
sending, in response to at least one first icon being designated in a state in which the plurality of first icons is being displayed in the first display region, the message according to the stylized and fixed mark/picture/graphic corresponding to the first icon designated to the communication destination corresponding to the second icon displayed in the second display region, via the wireless communication unit.

2. The method according to claim 1, wherein the plurality of messages according to stylized and fixed mark/picture/graphic include a first message according to stylized and fixed mark/picture/graphic for replying to a message according to stylized and fixed mark/picture/graphic from the communication destination.

3. The method according to claim 1, wherein the plurality of messages according to stylized and fixed mark/picture/graphic include a second message according to stylized and fixed mark/picture/graphic for replying in a case of the communication destination having addressed the message according to stylized and fixed mark/picture/graphic sent by the electronic device.

4. The method according to claim 1, wherein the step of displaying further includes:
displaying, in response to receiving a message according to stylized and fixed mark/picture/graphic from the communication destination corresponding to the second icon via the wireless communication unit, a first icon corresponding to the message according to stylized and fixed mark/picture/graphic received in the second display region to be associated with the second icon corresponding to the communication destination displayed in the second display region.

5. An electronic device comprising:
a wireless communication unit;
a display unit;
a display control unit that displays a plurality of first icons corresponding to a plurality of messages according to stylized and fixed mark/picture/graphic in a first display region of the display unit, and displays a second icon corresponding to a communication destination in a second display region of the display unit; and
a message processing unit that, in response to at least one first icon being designated in a state in which the plurality of first icons is being displayed in the first display region, sends the message according to stylized and fixed mark/picture/graphic corresponding to the first icon designated to the communication destination corresponding to the second icon displayed in the second region.

6. The electronic device according to claim 5, wherein the plurality of messages according to stylized and fixed mark/picture/graphic includes a first message according to stylized and fixed mark/picture/graphic for replying to a message according to stylized and fixed mark/picture/graphic received from a communication destination.

7. The electronic device according to claim 5, wherein the plurality of message according to stylized and fixed mark/picture/graphic includes a second message according to stylized and fixed mark/picture/graphic for replying in a case of the communication destination corresponding to the message according to stylized and fixed mark/picture/graphic sent by the electronic device.

8. The electronic device according to claim 5, wherein the display control unit,
in response to receiving a message according to stylized and fixed mark/picture/graphic from the communication destination corresponding to the second icon via the wireless communication unit, further displays a first icon corresponding to the message according to stylized and fixed mark/picture/graphic received in the second display region to be associated with the second icon corresponding to the communication destination displayed in the second display region.

9. A method for an electronic device including a wireless communication unit and a display unit to exchange messages according to stylized and fixed mark/picture/graphic with a communication destination, the method comprising the steps of:
displaying a second icon corresponding to a communication destination in a second display region of the display unit, and displaying a plurality of first icons corresponding to a plurality of messages according to stylized and fixed mark/picture/graphic in a first display region of the display unit; and
sending, in response to at least one second icon and one first icon being designated in a state in which a second icon corresponding to a communication destination is being displayed in the second display region and the plurality of first icons is being displayed in the first display region, a message according to stylized and fixed mark/picture/graphic that corresponds to the first icon designated to the communication destination corresponding to the second icon designated, via the wireless communication unit,
wherein the plurality of messages according to stylized and fixed mark/picture/graphic includes at least one predetermined message according to stylized and fixed mark/picture/graphic, which can reference a sent message according to stylized and fixed mark/picture/graphic.

10. The method according to claim 9, wherein the predetermined message according to stylized and fixed mark/picture/graphic is a message according to stylized and fixed mark/picture/graphic which conveys a cancellation intention of the sent message according to stylized and fixed mark/picture/graphic.

11. The method according to claim 9, wherein the step of displaying includes:
displaying, in response to receiving a message according to stylized and fixed mark/picture/graphic from the communication destination corresponding to the second icon via the wireless communication unit, a first icon corresponding to the message according to stylized and fixed mark/picture/graphic received in the second display region of the display unit to be associated with the second icon corresponding to the communication destination displayed in the second display region.

12. An electronic device comprising:
a wireless communication unit;
a display unit;
a display control unit that displays a second icon corresponding to a communication destination in a second display region of the display unit, and displays a plurality of first icons corresponding to a plurality of messages according to stylized and fixed mark/picture/graphic in a first display region of the display unit; and
a message processing unit that, in response to at least one second icon and one first icon being designated in a state in which a second icon corresponding to a communication destination is being displayed in the second display region and the plurality of first icons is being displayed in the first display region, sends a message according to stylized and fixed mark/picture/graphic that corresponds to the first icon designated to the communication destination corresponding to the second icon designated, via the wireless communication unit,
wherein the plurality of messages according to stylized and fixed mark/picture/graphic includes at least one predetermined message according to stylized and fixed mark/picture/graphic, which can reference a sent message according to stylized and fixed mark/picture/graphic.

13. The electronic device according to claim 12, wherein the predetermined message according to stylized and fixed mark/picture/graphic is a message according to stylized and fixed mark/picture/graphic which conveys a cancellation intention of the sent message according to stylized and fixed mark/picture/graphic.

14. The electronic device according to claim 12,
wherein, in response to receiving a message according to stylized and fixed mark/picture/graphic from the communication destination corresponding to the second icon via the wireless communication unit, the display control unit displays a first icon corresponding to the message according to stylized and fixed mark/picture/graphic received in the second display region of the display unit to be associated with the second icon corresponding to the communication destination displayed in the second display region.

15. The method according to claim 2, wherein the plurality of messages according to stylized and fixed mark/picture/graphic include a second message according to stylized and fixed mark/picture/graphic for replying in a case of the communication destination having addressed the message according to stylized and fixed mark/picture/graphic sent by the electronic device.

16. The method according to claim 2, wherein the step of displaying further includes:
displaying, in response to receiving a message according to stylized and fixed mark/picture/graphic from the communication destination corresponding to the second icon via the wireless communication unit, a first icon corresponding to the message according to stylized and fixed mark/picture/graphic received in the second display region to be associated with the second icon corresponding to the communication destination displayed in the second display region.

17. The method according to claim 3, wherein the step of displaying further includes:
displaying, in response to receiving a message according to stylized and fixed mark/picture/graphic from the communication destination corresponding to the second icon via the wireless communication unit, a first icon corresponding to the message according to stylized and fixed mark/picture/graphic received in the second display region to be associated with the second icon corresponding to the communication destination displayed in the second display region.

18. The electronic device according to claim 6, wherein the plurality of message according to stylized and fixed mark/picture/graphic includes a second message according to stylized and fixed mark/picture/graphic for replying in a case of the communication destination corresponding to the message according to stylized and fixed mark/picture/graphic sent by the electronic device.

19. The electronic device according to claim 6, wherein the display control unit,
in response to receiving a message according to stylized and fixed mark/picture/graphic from the communication destination corresponding to the second icon via the wireless communication unit, further displays a first icon corresponding to the message according to stylized and fixed mark/picture/graphic received in the second display region to be associated with the second icon corresponding to the communication destination displayed in the second display region.

20. The electronic device according to claim 7, wherein the display control unit,
in response to receiving a message according to stylized and fixed mark/picture/graphic from the communication destination corresponding to the second icon via the wireless communication unit, further displays a first icon corresponding to the message according to stylized and fixed mark/picture/graphic received in the second display region to be associated with the second icon corresponding to the communication destination displayed in the second display region.
